(19) United States
(12) Patent Application Publication
(10) Pub. No.: US 2023/0124595 A1
(43) Pub. Date: Apr. 20, 2023

(54) METHOD AND APPARATUS FOR MANAGING SLICE BASED CELL RESELECTION PRIORITIES IN WIRELESS COMMUNICATION SYSTEM

(71) Applicant: Samsung Electronics Co., Ltd., Gyeonggi-do (KR)

(72) Inventors: Sangyeob JUNG, Gyeonggi-do (KR); Anil AGIWAL, Gyeonggi-do (KR); Hyunjeong KANG, Gyeonggi-do (KR)

(21) Appl. No.: 17/968,250

(22) Filed: Oct. 18, 2022

(30) Foreign Application Priority Data
Oct. 18, 2021 (KR) 10-2021-0138270

(51) Int. Cl. H04W 36/00; H04W 36/08

(52) U.S. Cl. CPC H04W 36/0077; H04W 36/08; H04W 36/0016

(57) ABSTRACT

The disclosure relates to a 5G or 6G communication system for supporting a higher data rate. The disclosure relates to a method performed by a UE in a wireless communication system, which may include: camping on a first cell based on first system information (SI) received from the first cell of a base station; receiving, from the first cell, second system information including information related to slicing-based cell reselection; identifying a second cell to be reselected based on the information related to the slicing-based cell reselection and information about a priority of a slice group received through an upper layer; and performing a cell reselection procedure for the identified second cell.

### CROSS-REFERENCE TO RELATED APPLICATION

This application is based on and claims priority under 35 U.S.C. 119(a) to Korean Patent Application No. 10-2021-0138270, filed on Oct. 18, 2021, in the Korean Intellectual Property Office, the disclosure of which is incorporated herein by reference.

### BACKGROUND

### 1. Field

The disclosure relates generally to a wireless communication system, and more particularly, to a method and an apparatus for managing slice based cell reselection priorities in a wireless communication system or a next generation mobile communication system.

### 2. Description of Related Art

Fifth generation (5G) mobile communication technology defines a wide frequency band to make a fast transmission speed and a new service possible, and can be implemented not only in a frequency band equal to or lower than 6 GHz (“Sub 6 GHz” band), such as 3.5 GHz, but also in an ultrahigh frequency band (“Above 6 GHz”) called millimeter waves (mmWave), such as 28 GHz or 39 GHz. Further, in case of sixth generation (6G) mobile communication technology (referred to as a beyond 5G system), in order to achieve the transmission speed that is 50 times faster than that of the 5G mobile communication technology and ultralow latency that is reduced to 1/10 of the latency of the 5G mobile communication technology, implementation of the 6G mobile communication technology in the terahertz band (e.g., the band in the range of 95 GHz to 3 terahertz (3 THz)) has been considered.

Upon developing 5G mobile communication technology, with the aim to support services for enhanced mobile broadband (eMBB), ultra-reliable low-latency communications (URLLC), and massive machine-type communications (mMTC) and to satisfy performance requirements, standardization has been carried out for beamforming and massive multiple input-multiple output (MIMO) to mitigate a path loss of radio waves in an ultrahigh frequency band and to increase a transfer distance of the radio waves, various numerology supports (operation of a plurality of subcarrier spacings and the like) for efficient utilization of ultrahigh frequency resources and a dynamic operation for a slot format, an initial access technology for supporting multi-beam transmission and broadband, definition and operation of a bandwidth part (BWP), a new channel coding method, such as a polar code for high reliable transmission of a low density parity check (LDPC) code and control information for mass data transmission, L2 preprocessing, and network slicing for providing a dedicated network specialized in a specific service.

In consideration of services intended to be supported by the 5G mobile communication technology, discussions for the initial 5G mobile communication technology improvement and performance enhancement are underway, and the physical layer standardization has been carried out for technologies of vehicle-to-everything (V2X) to help the driving judgment of an autonomous vehicle and to increase user convenience based on the vehicle location and state information being transmitted by the vehicle itself, a new radio unlicensed (NR-U) for the purpose of a system operation to meet the requirements on various regulations in an unlicensed band, NR UE power saving, a non-terrestrial network (NTN) that is a UE-satellite direct communication for securing a coverage in an area where communication with a ground network is not possible, and positioning.

In addition, standardization in the field of a wireless interface architecture/protocol has also been carried out for technologies of the industrial internet of things (IMT) for a new service support through linking and fusion with other industries, an integrated access and backhaul (IAB) to provide a node for extending a network service area through an integrated support of a wireless backhaul link and an access link, mobility enhancement including a conditional handover and a dual active protocol stack (DAPS) handover, and a 2-step random access (e.g., 2-step random access channel (RACH) for NR) to simplify a random access procedure, and standardization in the field of a system architecture/service has also been carried out for a 5G base line architecture (e.g., service based architecture and service based interface) for grafting of network functions virtualization (NFV) and software-defined networking (SDN) technologies, and mobile edge computing (MEC) for being provided with a service based on a UE location.

In case that the 5G mobile communication system as described above is commercialized, it is expected that connected devices will be connected to a communication network, and accordingly, it will be necessary to enhance the function and performance of the 5G mobile communication system and to perform an integrated operation of the connected devices. New research is scheduled to be performed for 5G performance improvement and complexity reduction by utilizing the extended reality (XR) for efficiently supporting augmented reality (AR), virtual reality (VR), and mixed reality (MR), artificial intelligence (AI), and machine learning (ML), AI service support, meta bus service support, and drone communication.

Further, the development of the 5G mobile communication system will be able to become the basis for developments of not only the multi-antenna transmission technology, such as new waveforms, full dimension MIMO (FD-MIMO), array antennas, and large scale antennas, to secure the coverage in a terahertz band of 6G mobile communication technology, lenses and antennas based on meta materials to improve the coverage of the terahertz band signal, high-dimensional space multiplexing technology using orbital angular momentum (OAM), reconfigurable intelligent surface (RIS) technology, but also full duplex technology for frequency efficiency enhancement and system network improvement of the 6G mobile communication technology, AI-based communication technology to realize system optimization through utilization of a satellite and artificial intelligence (AI) from a design stage and internalization of an end-to-end AI support function, and next generation distributed computing technology to realize a service having complexity that exceeds the limits of UE computation capability by utilizing the ultrahigh performance communication and computing resources.

In particular, in case of updating all cells in a specific frequency in a slice-based cell reselection process, overhead may be increased, and in order to solve such a problem, it is necessary to provide information on which cells support (or do not support) the slice in the specific frequency.

### SUMMARY

The disclosure provides a method for managing a priority in a slice-based cell reselection process. Specifically, the disclosure provides a method for broadcasting information on cells that support or do not support a slice in a specific frequency through system information.

According to an aspect, a method is provided that is performed by a UE in a wireless communication system. A first cell of a base station is camped on based on first system information (SI) received from the first cell. Second SI including slicing-based cell reselection information is received from the first cell. A second cell to be reselected is identified based on the slicing-based cell reselection information and information about a priority of a slice group received through an upper layer. A cell reselection procedure is performed for the second cell.

According to an aspect, a method is provided that is performed by a base station in a wireless communication system. First SI necessary for a UE to camp on a first cell and second SI including slicing-based cell reselection information are identified. The first SI and the second SI are generated and transmitted.

According to an aspect, a UE in a wireless communication system is provided. The UE includes a transceiver configured to transmit and receive signals, and a controller connected to the transceiver. The controller is configured to camp on a first cell of a base station based on first SI received from the first cell, receive, from the first cell, second SI including slicing-based cell reselection information, identify a second cell to be reselected based on the slicing-based cell reselection information and information about a priority of a slice group received through an upper layer, and perform a cell reselection procedure for the second cell.

According to an aspect, a base station of a wireless communication system is provided. The base station includes a transceiver configured to transmit and receive signals, and a controller connected to the transceiver. The controller is configured to identify first SI necessary for a UE to amp on a first cell and second SI including slicing-based cell reselection information, generate the first SI and the second SI, and transmit the first SI and the second SI.

According to embodiments of the disclosure, the base station can broadcast whether to support a slice in the unit of a cell. Through this, it is possible to efficiently manage the priority for the cell reselection in the slice-based cell reselection process and to efficiently perform the whole cell reselection process.

### BRIEF DESCRIPTION OF THE DRAWINGS

The above and other aspects, features, and advantages of the present disclosure will be more apparent from the following detailed description when taken in conjunction with the accompanying drawings, in which:

FIG. 1A is a diagram illustrating the structure of a long term evolution (LTE) system, according to an embodiment;

FIG. 1B is a diagram illustrating a radio protocol structure of an LTE system, according to an embodiment;

FIG. 1C is a diagram illustrating the structure of a next generation mobile communication system, according to an embodiment;

FIG. 1D is a diagram illustrating a radio protocol structure of a next generation mobile communication system, according to an embodiment;

FIG. 1E is a diagram illustrating a procedure in which a UE in a radio resource control (RRC) idle (RRC_IDLE) mode or in an RRC inactive (RRC_INACTIVE) state performs a cell reselection evaluation procedure by applying cell reselection priority information, being broadcasted from system information in a next generation mobile communication system, according to an embodiment;

FIG. 1F is a diagram illustrating a procedure in which a UE in an RRC_IDLE mode or in an RRC_INACTIVE state performs a slice-based cell reselection evaluation procedure by applying slice-based cell reselection priority information, being broadcasted from system information in a next generation mobile communication system, according to an embodiment;

FIG. 1G is a block diagram illustrating the internal structure of a UE, according to an embodiment; and

FIG. 1H is a block diagram illustrating the constitution of an NR base station, according to an embodiment.

### DETAILED DESCRIPTION

Embodiments of the disclosure are described in detail with reference to the accompanying drawings. The same or similar components may be designated by the same or similar reference numerals although they are illustrated in different drawings. Detailed descriptions of constructions or processes known in the art may be omitted to avoid obscuring the subject matter of the disclosure.

In describing the embodiments, explanation of technical contents that are well known in the technical field to which the disclosure pertains and are not directly related to the disclosure will be omitted. This is to transfer the subject matter of the disclosure more clearly without obscuring the same through omission of unnecessary explanations.

For the same reason, in the accompanying drawings, some constituent elements are exaggerated, omitted, or briefly illustrated. Further, sizes of the respective constituent elements do not completely reflect the actual sizes thereof, and in the drawings, the same reference numerals may be used for the same or corresponding constituent elements across various figures.

The aspects and features of the disclosure and methods for achieving the aspects and features will be apparent by referring to the embodiments to be described in detail with reference to the accompanying drawings. However, the disclosure is not limited to the embodiments disclosed hereinafter, and it can be implemented in various different forms. The embodiments of the disclosure are provided only to complete the disclosure and to completely notify those of ordinary skill in the art to which the disclosure pertains of the category of the disclosure, and thus the disclosure is only defined within the scope of the appended claims. In the entire description of the disclosure, the same reference numerals are used for the same constituent elements.

In this case, it will be understood that each block of the flowchart illustrations, and combinations of blocks in the flowchart illustrations, can be performed by computer program instructions. These computer program instructions can be provided to a processor of a general purpose computer, special purpose computer, or other programmable data processing apparatus, such that the instructions, which are executed via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable data processing apparatus to produce a computer implemented process such that the instructions that are executed on the computer or other programmable data processing apparatus provide steps for implementing the functions specified in the flowchart block or blocks.

Also, each block of the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

In this case, the term “unit”, as used herein, means, but is not limited to, a software or hardware component, such as FPGA or ASIC, which performs certain tasks. However, “unit” is not meant to be limited to software or hardware. The term “unit” may advantageously be configured to reside on the addressable storage medium and configured to execute on one or more processors. Thus, “unit” may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and “units” may be combined into fewer components and “units” or further separated into additional components and “units”. Further, the components and “units” may be implemented to operate one or more CPUs in a device or a security multimedia card.

In the following description, a term to identify an access node, a term to denote network entities, a term to denote messages, a term to denote an interface between network entities, and a term to denote a variety of identity information have been exemplified for convenience in explanation. Accordingly, the disclosure is not limited to the following terms, and other terms to denote targets having equivalent technical meanings may be used.

Hereinafter, for convenience in explanation, terms and names defined in the 3rd generation partnership project long term evolution (3GPP LTE) standards are used in the disclosure. However, the disclosure is not restricted by the terms and names, and it may be equally applied to systems complying with other standards. Herein, for convenience in explanation, an eNB may be interchangeably used with a gNB. That is, a base station that is explained as an eNB may represent a gNB.

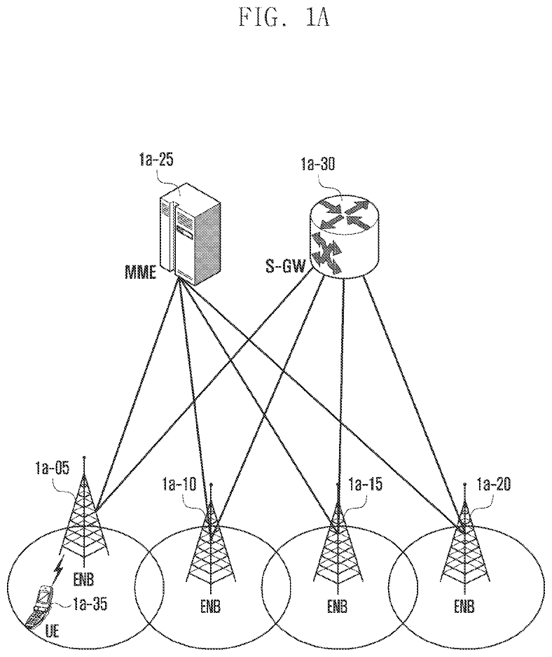

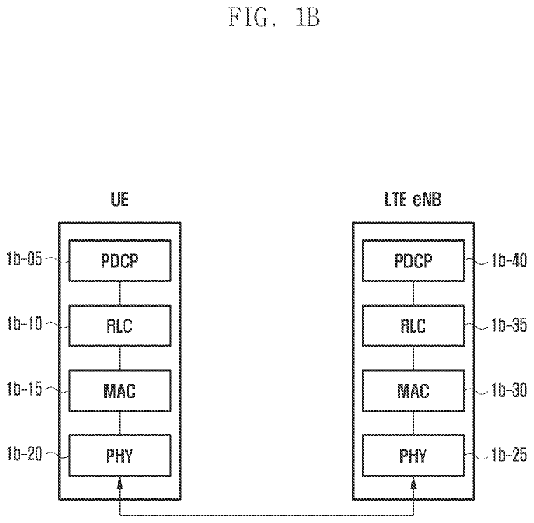

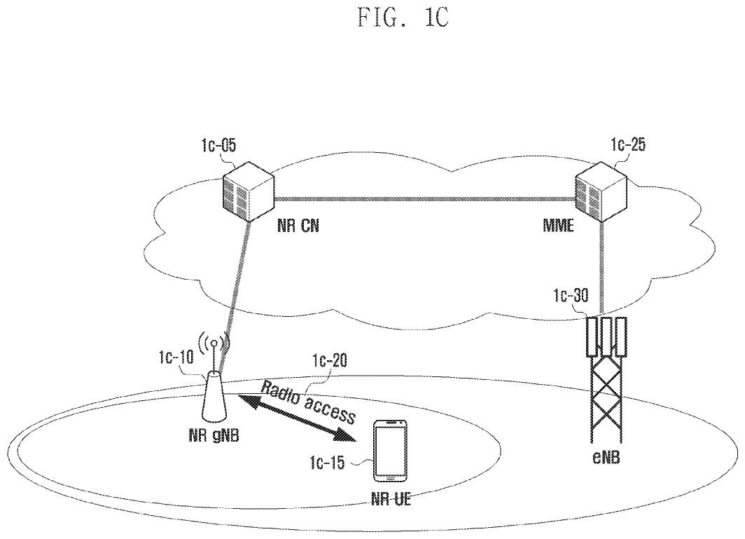

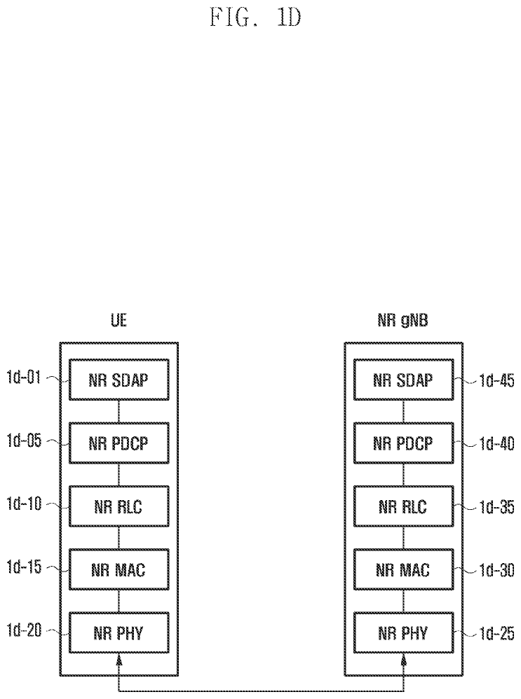

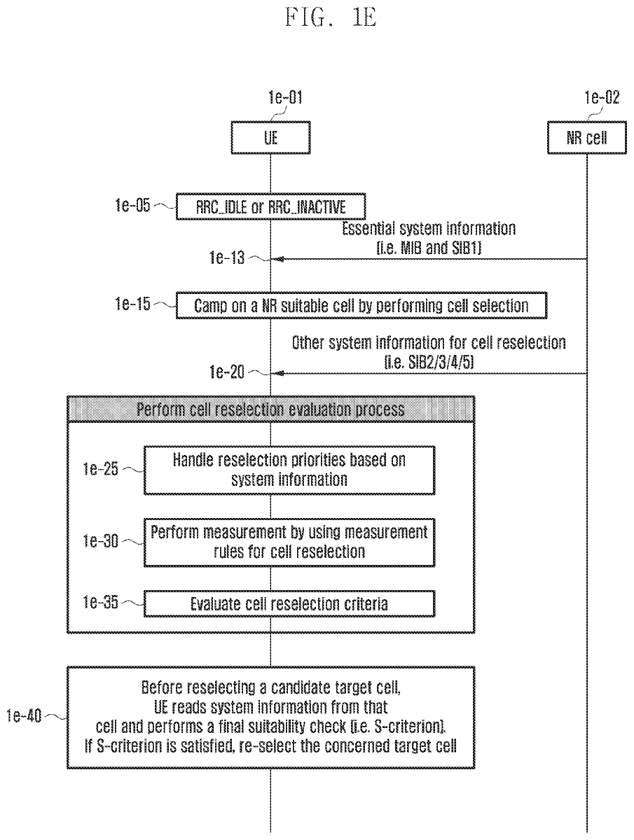

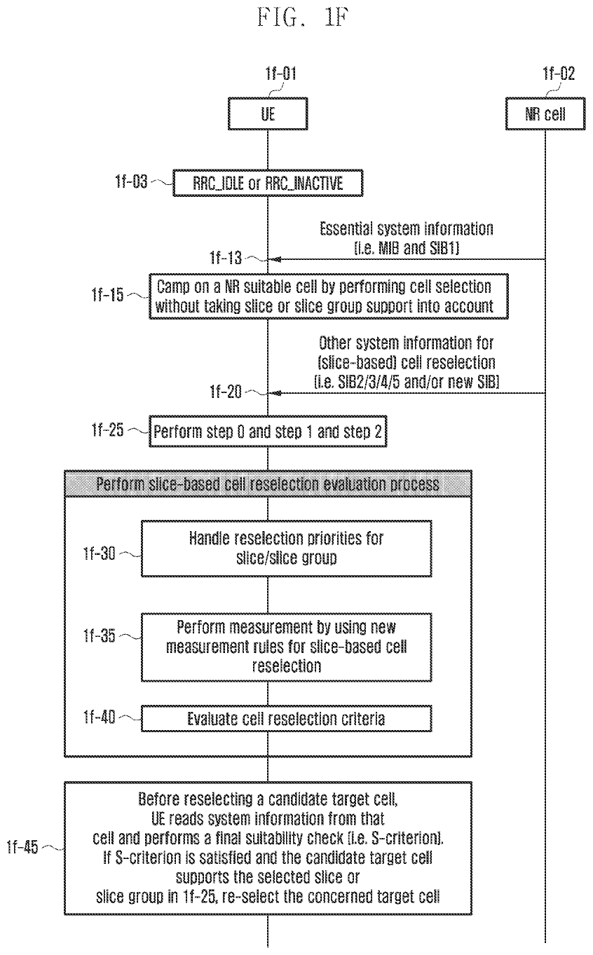

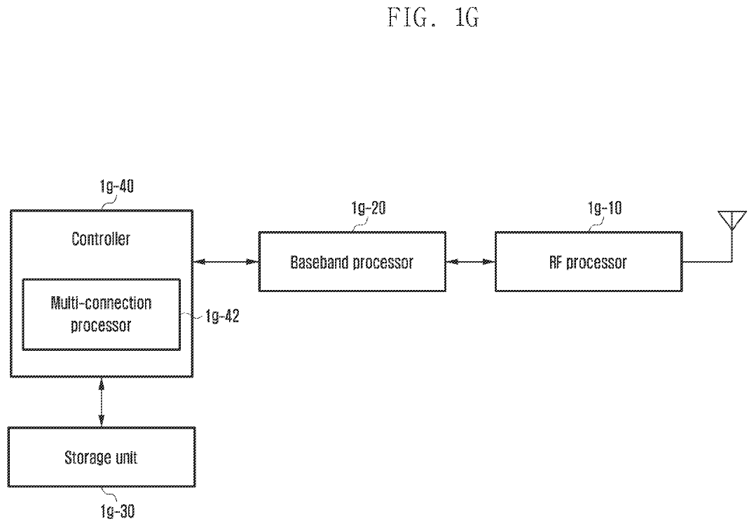

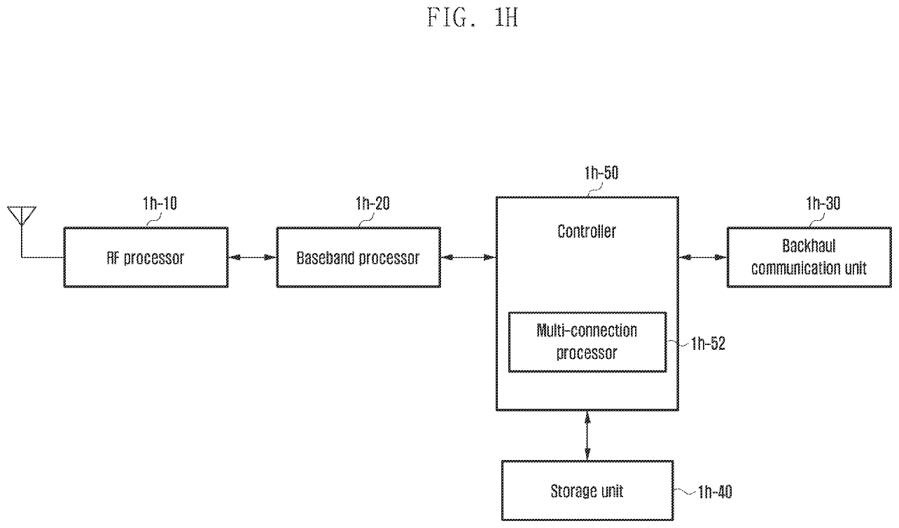

FIG. 1A is a diagram illustrating the structure of an LTE system, according to an embodiment.

With reference to FIG. 1A, as illustrated, a radio access network (RAN) of an LTE system is composed of evolved node Bs (hereinafter referred to as “ENBs”, “node Bs”, or “base stations”) 1a-05, 1a-10, 1a-15, and 1a-20, a mobility management entity (MME) 1a-25, and a serving-gateway (S-GW) 1a-30. A user equipment (hereinafter referred to as “UE” or “terminal”) 1a-35 accesses an external network through the ENBs 1a-05 to 1a-20 and the S-GW 1a-30.

In FIG. 1A, the ENBs 1a-05 to 1a-20 correspond to existing node Bs of a UMTS system. The ENB is connected to the UE 1a-35 on a radio channel, and plays a more complicated role than that of the existing node B. In the LTE system, since all user traffic including a real-time service, such as, for example, a voice over Internet protocol (VoIP), are serviced on shared channels, entities that perform scheduling through gathering of state information, such as, for example, a buffer state, an available transmission power state, and a channel state of UEs, are necessary, and the ENBs 1a-05 to 1a-20 take charge of this. In general, one ENB controls a plurality of cells. For example, in order to implement a transmission speed of 100 Mbps, the LTE system uses, for example, orthogonal frequency division multiplexing (OFDM) as a radio access technology (RAT) in a bandwidth of 20 MHz. Further, the LTE system adopts an adaptive modulation and coding (AMC) scheme that determines a modulation scheme and a channel coding rate to match the channel state of the UE. The S-GW 1a-30 is an entity that provides a data bearer, and generates or removes the data bearer under the control of the MME 1a-25. The MME is an entity that takes charge of not only a mobility management function for the UE, but also various kinds of control functions, and is connected to the plurality of base stations.

FIG. 1B is a diagram illustrating a radio protocol structure of an LTE system, according to an embodiment.

With reference to FIG. 1B, in a UE or an ENB, a radio protocol of an LTE system is composed of a packet data convergence protocol (PDCP) 1b-05 or 1b-40, a radio link control (RLC) 1b-10 or 1b-35, and a medium access control (MAC) 1b-15 or 1b-30. The packet data convergence protocol (PDCP) 1b-05 or 1b-40 takes charge of IP header compression/decompression operations. The main functions of the PDCP are summarized as follows.
Header compression and decompression: robust header compression (ROHC) only
Transfer of user data
In-sequence delivery of upper layer packet data units (PDUs) at PDCP re-establishment procedure for RLC acknowledge mode (AM)
For split bearers in dual connectivity (DC) (only support for RLC AM): PDCP PDU routing for transmission and PDCP PDU reordering for reception
Duplicate detection of lower layer service data units (SDUs) at PDCP re-establishment procedure for RLC AM
Retransmission of PDCP SDUs at handover and, for split bearers in DC, of PDCP PDUs at PDCP data-recovery procedure, for RLC AM
Ciphering and deciphering
Timer-based SDU discard in uplink

A radio link control (RLC) 1b-10 or 1b-35 performs an ARQ operation by reconfiguring a (PDCP PDU) with a suitable size. Main functions of the RLC are summarized as follows.
Transfer of upper layer PDUs
Error correction through automatic repeat request (ARQ) (only for acknowledge mode (AM) data transfer)
Concatenation, segmentation and reassembly of RLC SDUs (only for unacknowledge mode (UM) and AM data transfer)
Re-segmentation of RLC data PDUs (only for AM data transfer)
Reordering of RLC data PDUs (only for UM and AM data transfer)
Duplicate detection (only for UM and AM data transfer)
Protocol error detection (only for AM data transfer)
RLC SDU discard (only for UM and AM data transfer)
RLC re-establishment

The MAC 1b-15 or 1b-30 is connected to several RLC layer devices constituted in one UE, and performs multiplexing of RLC PDUs into a MAC PDU and demultiplexing of the RLC PDUs from the MAC PDU. The main functions of the MAC are summarized as follows.
Mapping between logical channels and transport channels
Multiplexing/demultiplexing of MAC SDUs belonging to one or different logical channels into/from transport blocks (TB) delivered to/from the physical layer on transport channels
Scheduling information reporting
Error correction through hybrid automatic repeat request (HARM)
Priority handling between logical channels of one UE
Priority handling between UEs by means of dynamic scheduling
Multimedia broadcast multicast service (MBMS) identification
Transport format selection
Padding

A physical layer 1b-20 or 1b-25 performs channel coding and modulation of upper layer data, and makes and transmits orthogonal frequency division multiplexing (OFDM) symbols on a radio channel, or performs demodulation and channel decoding of the OFDM symbols received on the radio channel and transfers the OFDM symbols to an upper layer.

FIG. 1C is a diagram illustrating the structure of a next generation mobile communication system, according to an embodiment.

With reference to FIG. 1C, as illustrated, a RAN of a next generation mobile communication system (hereinafter, NR or 2g) is composed of a new radio node B (hereinafter, NR gNB or NR base station) 1c-10, and a new radio core network (NR CN) 1c-05. A new radio user equipment (hereinafter, NR UE or UE) 1c-15 accesses an external network through the NR gNB 1c-10 and the NR CN 1c-05.

In FIG. 1C, the NR gNB 1c-10 corresponds to an evolved Node B (eNB) of the existing LTE system. The NR gNB 1c-10 is connected to the NR UE 1c-15 on a radio channel, and can provide a more superior service than the service of the existing Node B. In the next generation mobile communication system, all user traffic is serviced on shared channels, and thus, there is a need for a device that performs scheduling through consolidation of state information, such as a buffer state, an available transmission power state, and a channel state of UEs, and the NR gNB 1c-10 takes charge of this. In general, one NR gNB controls a plurality of cells. In order to implement ultrahigh-speed data transmission as compared with the existing LTE, a bandwidth that is equal to or higher than the existing maximum bandwidth may be applied, and a beamforming technology may be additionally grafted in consideration of the OFDM as the RAT. Further, the NR gNB 1c-10 adopts an AMC scheme that determines the modulation scheme and the channel coding rate to match the channel state of the UE. The NR CN 1c-05 performs functions of mobility support, bearer setup, and quality of service (QoS) configuration. The NR CN is a device that takes charge of not only a mobility management function for the UE but also various kinds of control functions, and is connected to a plurality of base stations. Further, the next generation mobile communication system may interwork with the existing LTE system, and the NR CN is connected to the MME 1c-25 through a network interface. The MME is connected to the eNB 1c-30 that is the existing base station.

FIG. 1D is a diagram illustrating a radio protocol structure of a next generation mobile communication system, according to an embodiment.

Specifically, FIG. 1D is a diagram illustrating the radio protocol structure of the next generation mobile communication system to which the disclosure can be applied.

With reference to FIG. 1D, in the UE or NR base station, the radio protocol of the next generation mobile communication system is composed of an NR service data adaption protocol (SDAP) 1d-01 or 1d-45, an NR PDCP 1d-05 or 1d-40, an NR RLC 1d-10 or 1d-35, an NR MAC 1d-15 or 1d-30, and an NR PHY 1d-20 or 1d-25.

The main functions of the NR SDAP 1d-01 or 1d-45 may include some of the following functions.
Transfer of user plane data
Mapping between a QoS flow and a data radio bearer (DRB) for both downlink (DL) and uplink (UL)
Marking QoS flow identifier (ID) in both DL and UL packets
Reflective QoS flow to DRB mapping for the UL SDAP PDUs

With respect to the SDAP layer device, the UE may be configured whether to use a header of the SDAP layer device or whether to use the function of the SDAP layer device for each PDCP layer device, bearer, or logical channel through an RRC message. If the SDAP header is configured, the UE may indicate that the UE can update or reconfigure mapping information on the uplink and downlink QoS flow and the data bearer through a non-access stratum (NAS) QoS reflective configuration 1-bit indicator (NAS reflective QoS) and an access stratum (AS) QoS reflective configuration 1-bit indicator (AS reflective QoS) of an SDAP header. The SDAP header may include QoS flow ID information representing the QoS. The QoS information may be used as a data processing priority for supporting a smooth service and scheduling information.

The main functions of the NR PDCP 1d-05 or 1d-40 may include some of the following functions.
Header compression and decompression: ROHC only
Transfer of user data
In-sequence delivery of upper layer PDUs
Out-of-sequence delivery of upper layer PDUs
PDCP PDU reordering for reception
Duplicate detection of lower layer SDUs
Retransmission of PDCP SDUs
Ciphering and deciphering
Timer-based SDU discard in an uplink

As described above, reordering of the NR PDCP device may mean reordering of PDCP PDUs received from a lower layer based on PDCP sequence numbers (SNs), and may include transferring of data to an upper layer in the order of reordering. Further, the reordering may include immediate transferring of the data without considering the order, recording of lost PDCP PDUs through reordering, status report for the lost PDCP PDUs to a transmission side, and retransmission request for the lost PDCP PDUs.

The main functions of the NR RLC 1d-10 or 1d-35 may include some of the following functions.
Transfer of upper layer PDUs
In-sequence delivery of upper layer PDUs
Out-of-sequence delivery of upper layer PDUs
Error correction through an ARQ
Concatenation, segmentation, and reassembly of RLC SDUs
Re-segmentation of RLC data PDUs
Reordering of RLC data PDUs
Duplicate detection
Protocol error detection
RLC SDU discard
RLC reestablishment

As described above, the in-sequence delivery of the NR RLC device may mean the in-sequence delivery of RLC SDUs received from a lower layer to an upper layer, and in case that one original RLC SDU is segmented into several RLC SDUs to be received, the in-sequence delivery of the NR RLC device may include reassembly and delivery of the RLC SDUs and reordering of the received RLC PDUs based on an RLC sequence number (SN) or a PDCP SN. The in-sequence delivery of the NR RLC device may include recording of lost RLC PDUs through reordering, status report for the lost RLC PDUs to the transmission side, and retransmission request for the lost RLC PDUs. The in-sequence delivery of the NR RLC device may include in-sequence delivery of only RLC SDUs just before the lost RLC SDU to an upper layer if there is the lost RLC SDU, in-sequence delivery of all RLC SDUs received before a specific timer starts its operation to an upper layer if the timer has expired although there is the lost RLC SDU, or in-sequence delivery of all RLC SDUs received up to now to an upper layer if the specific timer has expired although there is the lost RLC SDU. Further, the NR RLC device may process the RLC PDUs in the order of their reception (in the order of arrival, regardless of the order of a serial number or sequence number), and may transfer the processed RLC PDUs to the PDCP device in an out-of-sequence delivery manner, and in case of receiving segments, the NR RLC device may receive the segments stored in a buffer or to be received later, reconfigure and process them as one complete RLC PDU, and then transfer the processed RLC PDU to the PDCP device. The NR RLC layer may not include a concatenation function, and the function may be performed by an NR MAC layer or may be replaced by a multiplexing function of the NR MAC layer.

As described above, the out-of-sequence delivery of the NR RLC device may mean a function of transferring the RLC SDUs received from a lower layer directly to an upper layer regardless of their order, and if one original RLC SDU is segmented into several RLC SDUs to be received, the out-of-sequence delivery of the NR RLC device may include reassembly and delivery of the RLC SDUs. Further, the out-of-sequence delivery of the NR RLC device may include functions of storing and ordering the RLC SNs or PDCP SNs of the received RLC PDUs and recording of the lost RLC PDUs.

The NR MAC 1d-15 or 1d-30 may be connected to several NR RLC layer devices configured in one UE, and the main functions of the NR MAC may include some of the following functions.
Mapping between logical channels and transport channels
Multiplexing/demultiplexing of MAC SDUs
Scheduling information reporting
HARQ function (error correction through HARQ)
Priority handling between logical channels of one UE
Priority handling between UEs by means of dynamic scheduling
MBMS service identification
Transport format selection
Padding

The NR PHY layer 1d-20 or 1d-25 may perform channel coding and modulation of upper layer data to make and transmit OFDM symbols on a radio channel, or may perform demodulation and channel decoding of the OFDM symbols received on the radio channel to transfer the demodulated and channel-decoded symbols to an upper layer.

FIG. 1E is a diagram illustrating a procedure in which a UE in an RRC_IDLE mode or in an RRC_INACTIVE state performs a cell reselection evaluation procedure by applying cell reselection priority information, being broadcasted from system information in a next generation mobile communication system, according to an embodiment.

The cell reselection evaluation procedure may refer to a procedure in which a UE in an RRC_IDLE mode or in an RRC_INACTIVE state determines whether to maintain the present serving cell or to reselect a neighboring cell as the cell when the service quality of a serving cell on which the UE currently camps becomes lower than the service quality of the neighboring cell due to a specific reason or movement.

In case of a handover, whether to operate the handover is determined by a network (access and mobility management function (AMF) or source gNB), whereas in case of a cell reselection, the UE in the RRC idle mode or in the RRC inactive state can determine whether to operate the cell reselection by itself based on a cell measurement value. The cell to be re-selected by the UE may mean a cell that uses the same NR frequency (NR intra-frequency or serving NR frequency) as that of the serving cell on which the UE currently camps, a cell that uses the NR frequency (NR inter-frequency) different from that of the serving cell, or a cell that is in the frequency (inter-RAT frequency) using another RAT.

Herein, the serving cell on which the UE currently camps is featured so that a cell reselection priority value mapped onto the NR frequency to which the serving cell belongs is mandatorily broadcasted as system information. Accordingly, in case of determining cell reselection priorities (in case of handling reselection priorities) based on the system information, based on the cell reselection priority value mapped onto the NR frequency to which the serving cell belongs, the UE in the RRC idle mode or in the RRC inactive state may determine whether the cell reselection priority for each NR inter-frequency or inter-RAT frequency is the same cell reselection priority as that of the NR frequency to which the serving cell belongs, whether the cell reselection priority is higher than the cell reselection priority of the NR frequency to which the serving cell belongs, or whether the cell reselection priority is lower than the cell reselection priority of the NR frequency to which the serving cell belongs. Further, the UE may perform frequency measurement by applying measurement rules for cell reselection based on the cell reselection priorities determined by frequencies, and may reselect a neighboring cell that satisfies the cell reselection criteria.

Referring back to FIG. 1E, a UE 1e-01 may be in the RRC idle (RRC_IDLE) mode or in the RRC inactive (RRC_INACTIVE) state (1e-05).

At 1e-13, the UE that is in the RRC idle mode or in the RRC inactive state may obtain essential system information from an NR cell 1e-02. Herein, a master information block (MIB) and a system information block 1 (SIB1) may be called essential system information.

At 1e-15, the UE in the RRC idle mode or in the RRC inactive state may perform a cell selection procedure based on the essential system information obtained at 1e-13. That is, the UE may search for an NR suitable cell that belongs to the selected PLMN or SNPN, and may camp on the corresponding cell. The cell on which the UE camps may be called a serving cell. Herein, in case that conditions in Table 1 are satisfied based on the 3GPP standard document “38.304: user equipment (UE) procedures in idle mode and RRC inactive state”, the cell may be defined as a suitable cell.

TABLE 1
suitable cell:
For UE not operating in SNPN Access Mode, a cell is considered as suitable if the
following conditions are fulfilled:
-The cell is part of either the selected PLMN or the registered PLMN or PLMN of the
Equivalent PLMN list, and for that PLMN either:
-The PLMN-ID of that PLMN is broadcast by the cell with no associated CAG-IDs and
CAG-only indication in the UE for that PLMN (TS 23.501 [10]) is absent or false;
-Allowed CAG list in the UE for that PLMN (TS 23.501 [10]) includes a CAG-ID
broadcast by the cell for that PLMN;
-The cell selection criteria are fulfilled, see clause 5.2.3.2.
According to the latest information provided by NAS:
-The cell is not barred, see clause 5.3.1;
-The cell is part of at least one TA that is not part of the list of “Forbidden Tracking Areas
for Roaming” (TS 22.011 [18]), which belongs to a PLMN that fulfills the first bullet
above.
For UE operating in SNPN Access Mode, a cell is considered as suitable if the following
conditions are fulfilled:
-The cell is part of either the selected SNPN or the registered SNPN of the UE;
-The cell selection criteria are fulfilled, see clause 5.2.3.2;
According to the latest information provided by NAS:
-The cell is not barred, see clause 5.3.1;
-The cell is part of at least one TA that is not part of the list of “Forbidden Tracking Areas
for Roaming” which belongs to either the selected SNPN or the registered SNPN of the
UE.

For reference, if Equation (1) is satisfied, the UE may determine that the cell selection criteria are fulfilled.

Srxlev>0 AND Squal>0

where

Srxlev=Qᵣₓₗₑᵥₘₑₐₛ−(Qᵣₓₗₑᵥₘᵢₙ+Q_{rxlevminoffset})−P_{compensation}−Qoffsetₜₑₘₚ

Squal=Q_{qualmeas}−(Q_{qualmin}+Q_{qualminoffset})−Qoffsetₜₑₘₚ (1)

Parameters used in Equation (1) are defined with reference to the 3GPP standard document “38.304: user equipment (UE) procedures in idle mode and RRC inactive state”.

At 1e-20, in order to perform a cell reselection evaluation procedure, the UE in the RRC idle mode or in the RRC inactive state may obtain system information (e.g., SIB2, SIB3, SIB4, and SIB5) that contains cell reselection information from the serving cell 1e-02. The SIB2 may include NR intra-frequency cell reselection information excluding information/parameter being commonly applied when the UE reselects NR intra-frequency, NR inter-frequency, or inter-RAT frequency cell and information related to an NR intra-frequency neighboring cell. As an example, the SIB2 may include one-cell reselection priority configuration information for a serving NR frequency (frequency to which the current camped-on cell belongs). The cell reselection priority configuration information may mean cellReselectionPriority and cellReselectionSubPriority. Specifically, the cellReselectionPriority may store an integer value (e.g., one integer value of 0 to 7), and the cellReselectionSubPriority may store a decimal value (e.g., one decimal value of 0.2, 0.4, 0.6, and 0.8). If the cellReselectionPriority and the cellReselectionSubPriority are signaled in all, the UE may derive the cell reselection priority value by adding the two values. For reference, a larger cell reselection priority value means a higher priority. The serving cell is featured to mandatorily broadcast the cellReselectionPriority mapped onto the serving NR frequency through the SIB2, and since the cellReselectionSubPriority is optionally broadcasted, the cell reselection priority configuration information is featured to be mandatorily broadcasted at the serving NR frequency. Specifically, the cell reselection configuration information being broadcasted through the SIB2 may be as in Table 2 below.

TABLE 2

| | |
|---|---|
| SIB2 ::= | SEQUENCE { |
| cellReselectionInfoCommon | SEQUENCE { |

| nrofSS-BlocksToAverage | | INTEGER (2..maxNrofSS- |
|---|---|---|
| BlocksToAverage) | OPTIONAL, | -- Need S |

| | |
|---|---|
| absThreshSS-BlocksConsolidation | ThresholdNR |

| | |
|---|---|
| OPTIONAL, | -- Need S |

| | |
|---|---|
| rangeToBestCell | RangeToBestCell |

| | |
|---|---|
| OPTIONAL, | -- Need R |

| | |
|---|---|
| q-Hyst | ENUMERATED { |
| | dB0, dB1, dB2, dB3, dB4, |

dB5, dB6, dB8, dB10,

dB12, dB14, dB16, dB18,

dB20, dB22, dB24},

| | |
|---|---|
| speedStateReselectionPars | SEQUENCE { |

| | |
|---|---|
| mobility StateParameters | MobilityStateParameters, |
| q-HystSF | SEQUENCE { |
| sf-Medium | ENUMERATED {dB-6, |

dB-4, dB-2, dB0},

| | |
|---|---|
| sf-High | ENUMERATED {dB-6, dB- |

```
4, dB-2, dB0}
      }
    }
```

| | |
|---|---|
| OPTIONAL, | -- Need R |

```
  ...
  },
```

| | |
|---|---|
| cellReselectionServingFreqInfo | SEQUENCE { |

| | |
|---|---|
| s-NonIntraSearchP | ReselectionThreshold |

| | |
|---|---|
| OPTIONAL, | -- Need S |

| | |
|---|---|
| s-NonIntraSearchQ | ReselectionThresholdQ |

| | |
|---|---|
| OPTIONAL, | -- Need S |

| | |
|---|---|
| threshServingLowP | ReselectionThreshold, |
| threshServingLowQ | ReselectionThresholdQ |

| | |
|---|---|
| OPTIONAL, | -- Need R |

| | |
|---|---|
| cellReselectionPriority | CellReselectionPriority, |

| | |
|---|---|
| cellReselectionSubPriority | CellReselectionSubPriority |

| | |
|---|---|
| OPTIONAL, | -- Need R |

```
    ...
  },
```

| | |
|---|---|
| intraFreqCellReselectionInfo | SEQUENCE { |

| | |
|---|---|
| q-RxLevMin | Q-RxLevMin, |
| q-RxLevMinSUL | Q-RxLevMin |

| | |
|---|---|
| OPTIONAL, | -- Need R |

| | |
|---|---|
| q-QualMin | Q-QualMin |

| | |
|---|---|
| OPTIONAL, | -- Need S |

| | |
|---|---|
| s-IntraSearchP | ReselectionThreshold, |

| | |
|---|---|
| s-IntraSearchQ | ReselectionThresholdQ |

| | |
|---|---|
| OPTIONAL, | -- Need S |

| | |
|---|---|
| t-ReselectionNR | T-Reselection, |
| frequencyBandList | MultiFrequencyBandListNR-SIB |

| | |
|---|---|
| OPTIONAL, | -- Need S |

| | |
|---|---|
| frequencyBandListSUL | MultiFrequencyBandListNR-SIB |

| | |
|---|---|
| OPTIONAL, | -- Need R |

| | |
|---|---|
| p-Max | P-Max |

| | |
|---|---|
| OPTIONAL, | -- Need S |

| | |
|---|---|
| smtc | SSB-MTC |

| | |
|---|---|
| OPTIONAL, | -- Need S |

| | |
|---|---|
| ss-RSSI-Measurement | SS-RSSI-Measurement |

| | |
|---|---|
| OPTIONAL, | -- Need R |

| | |
|---|---|
| ssb-ToMeasure | SSB-ToMeasure |

| | |
|---|---|
| OPTIONAL, | -- Need S |

| | |
|---|---|
| deriveSSB-IndexFromCell | BOOLEAN, |

```
    ...,
    [[
```

| | |
|---|---|
| t-ReselectionNR-SF | SpeedStateScaleFactors |

| | |
|---|---|
| OPTIONAL | -- Need N |

```
    ]],
    [[
```

| | |
|---|---|
| smtc2-LP-r16 | SSB-MTC2-LP-r16 |

| | |
|---|---|
| OPTIONAL, | -- Need R |

| | |
|---|---|
| ssb-PositionQCL-Common-r16 | SSB-PositionQCL-Relation-r16 |

| | |
|---|---|
| OPTIONAL | -- Cond SharedSpectrum |

```
    ]]
  },
  ...
  [[
```

| | |
|---|---|
| relaxedMeasurement-r16 | SEQUENCE { |
| lowMobilityEvaluation-r16 | SEQUENCE { |

| | |
|---|---|
| s-SearchDeltaP-r16 | ENUMERATED { |
| | dB3, dB6, dB9, dB12, |

dB15,

spare3, spare2,

spare1},

| | |
|---|---|
| t-SearchDeltaP-r16 | ENUMERATED { |
| | s5, s10, s20, s30, s60, |

s120, s180,

s240, s300, spare7,

spare6, spare5,

spare4, spare3, spare2,

spare1}
}

| | |
|---|---|
| OPTIONAL, | -- Need R |

| | |
|---|---|
| cellEdgeEvaluation-r16 | SEQUENCE { |

| | |
|---|---|
| s-SearchThresholdP-r16 | ReselectionThreshold, |
| s-SearchThresholdQ-r16 | ReselectionThresholdQ |

| | |
|---|---|
| OPTIONAL | -- Need R |

}

| | |
|---|---|
| OPTIONAL, | -- Need R |

| | | |
|---|---|---|
| combineRelaxedMeasCondition-r16 | ENUMERATED | {true} |

| | |
|---|---|
| OPTIONAL, | -- Need R |

| | | |
|---|---|---|
| highPriorityMeasRelax-r16 | ENUMERATED | {true} |

| | |
|---|---|
| OPTIONAL | -- Need R |

}

| | |
|---|---|
| OPTIONAL | -- Need R |

]]
}

| | |
|---|---|
| RangeToBestCell | ::= Q-OffsetRange |

The SIB3 may include a neighboring cell information/parameter for the UE in the RRC idle mode or in the RRC inactive state to reselect the NR intra-frequency cell. As an example, through the SIB3, an NR intra-frequency cell list (intraFreqNeighCellList) for reselecting the NR intra-frequency cell or a cell list (intraFreqBlackCellList) in which NR intra-frequency cell reselection is not allowed may be broadcasted. Specifically, through the SIB3, information in Table 3 below may be broadcasted.

TABLE 3

| | |
|---|---|
| SIB3 ::= | SEQUENCE { |

| | |
|---|---|
| intraFreqNeighCellList | IntraFreqNeighCellList |

OPTIONAL, -- Need R

| | |
|---|---|
| intraFreqBlackCellList | IntraFreqBlackCellList |

OPTIONAL, -- Need R

| | |
|---|---|
| lateNonCriticalExtension | OCTET STRING |

```
OPTIONAL,
  ...,
  [[
```

| | |
|---|---|
| intraFreqNeighCellList-v1610 | IntraFreqNeighCellList-v1610 |

OPTIONAL, -- Need R

| | |
|---|---|
| intraFreqWhiteCellList-r16 | IntraFreqWhiteCellList-r16 |

OPTIONAL, -- Cond SharedSpectrum2

| intraFreqCAG-CellList-r16 | SEQUENCE (SIZE (1..maxPLMN)) OF | |
|---|---|---|
| IntraFreqCAG-CellListPerPLMN-r16 | OPTIONAL | -- Need R |

]]
}

| | |
|---|---|
| IntraFreqNeighCellList ::= | SEQUENCE (SIZE (1..maxCellIntra)) OF |

IntraFreqNeighCellInfo

| | |
|---|---|
| IntraFreqNeighCellList-v1610::= | SEQUENCE (SIZE (1..maxCellIntra)) OF |

IntraFreqNeighCellInfo-v1610

| | |
|---|---|
| IntraFreqNeighCellInfo ::= | SEQUENCE { |
| physCellId | PhysCellId, |
| q-OffsetCell | Q-OffsetRange, |

| | |
|---|---|
| q-RxLevMinOffsetCell | INTEGER (1..8) |

OPTIONAL, -- Need R

| | |
|---|---|
| q-RxLevMinOffsetCellSUL | INTEGER (1..8) |

OPTIONAL, -- Need R

| | |
|---|---|
| q-QualMinOffsetCell | INTEGER (1..8) |

OPTIONAL, -- Need R
...
}

| | |
|---|---|
| IntraFreqNeighCellInfo-v1610 ::= | SEQUENCE { |
| ssb-PositionQCL-r16 | SSB-PositionQCL-Relation-r16 |

OPTIONAL -- Cond SharedSpectrum2
}

| | |
|---|---|
| IntraFreqBlackCellList ::= | SEQUENCE (SIZE (1..maxCellBlack)) OF PCI- |

Range

| | |
|---|---|
| IntraFreqWhiteCellList-r16 ::= | SEQUENCE (SIZE (1..maxCellWhite)) OF PCI- |

Range
IntraFreqCAG-CellListPerPLMN-r16 ::= SEQUENCE {

| | |
|---|---|
| plmn-IdentityIndex-r16 | INTEGER (1..maxPLMN), |
| cag-CellList-r16 | SEQUENCE (SIZE (1..maxCAG-Cell- |

r16)) OF PCI-Range
}

The SIB4 may include information/parameter for the UE in the RRC idle mode or in the RRC inactive state to reselect the NR inter-frequency cell. As an example, through the SIB4, one or a plurality of NR inter-frequencies may be broadcasted, and one-cell reselection priority configuration information for each NR inter-frequency may be broadcasted. Although the cell reselection priority configuration information for each NR inter-frequency means the above-described contents (e.g., cellReselectionPriority and/or cellReselectionSubPriority each mapped onto the NR inter-frequency), the one-cell reselection priority configuration information for each inter-frequency is featured to be optionally broadcasted. Specifically, through the SIB4, information in Table 4 below may be broadcasted.

TABLE 4

| | |
|---|---|
| SIB4 ::= | SEQUENCE { |
| interFreqCarrierFreqList | InterFreqCarrierFreqList, |

| | |
|---|---|
| lateNonCriticalExtension | OCTET STRING |

```
OPTIONAL,
  ...,
  [[
```

| | |
|---|---|
| interFreqCarrierFreqList-v1610 | InterFreqCarrierFreqList-v1610 |

| | |
|---|---|
| OPTIONAL | -- Need R |

]]
}

| | |
|---|---|
| InterFreqCarrierFreqList ::= | SEQUENCE (SIZE (1..maxFreq)) OF |

InterFreqCarrierFreqInfo

| | |
|---|---|
| InterFreqCarrierFreqList-v1610 ::= | SEQUENCE (SIZE (1..maxFreq)) OF |

InterFreqCarrierFreqInfo-v1610

| | |
|---|---|
| InterFreqCarrierFreqInfo ::= | SEQUENCE { |
| dl-CarrierFreq | ARFCN-ValueNR, |

| | |
|---|---|
| frequencyBandList | MultiFrequencyBandListNR-SIB |

| | |
|---|---|
| OPTIONAL, | -- Cond Mandatory |

| | |
|---|---|
| frequencyBandListSUL | MultiFrequencyBandListNR-SIB |

| | |
|---|---|
| OPTIONAL, | -- Need R |

| | |
|---|---|
| nrofSS-BlocksToAverage | INTEGER (2..maxNrofSS- |

| | | |
|---|---|---|
| BlocksToAverage) | OPTIONAL, | -- Need S |

| | |
|---|---|
| absThreshSS-BlocksConsolidation | ThresholdNR |

| | |
|---|---|
| OPTIONAL, | -- Need S |

| | |
|---|---|
| smtc | SSB-MTC |

| | |
|---|---|
| OPTIONAL, | -- Need S |

| | |
|---|---|
| ssbSubcarrierSpacing | SubcarrierSpacing, |

| | |
|---|---|
| ssb-ToMeasure | SSB-ToMeasure |

| | |
|---|---|
| OPTIONAL, | -- Need S |

| | |
|---|---|
| deriveSSB-IndexFromCell | BOOLEAN, |

| | |
|---|---|
| ss-RSSi-Measurement | SS-RSSI-Measurement |

OPTIONAL,

| | |
|---|---|
| q-RxLevMin | Q-RxLevMin, |

| | |
|---|---|
| q-RxLevMinSUL | Q-RxLevMin |

| | |
|---|---|
| OPTIONAL, | -- Need R |

| | |
|---|---|
| q-QualMin | Q-QualMin |

| | |
|---|---|
| OPTIONAL, | -- Need S |

| | |
|---|---|
| p-Max | P-Max |

| | |
|---|---|
| OPTIONAL, | -- Need S |

| | |
|---|---|
| t-ReselectionNR | T-Reselection, |

| | |
|---|---|
| t-ReselectionNR-SF | SpeedStateScaleFactors |

| | |
|---|---|
| OPTIONAL, | -- Need S |

| | |
|---|---|
| threshX-HighP | ReselectionThreshold, |
| threshX-LowP | ReselectionThreshold, |
| threshX-Q | SEQUENCE { |

| | |
|---|---|
| threshX-HighQ | ReselectionThresholdQ, |
| threshX-LowQ | ReselectionThresholdQ |

}

| | |
|---|---|
| OPTIONAL, | -- Cond RSRQ |

| | |
|---|---|
| cellReselectionPriority | CellReselectionPriority |

| | |
|---|---|
| OPTIONAL, | -- Need R |

| | |
|---|---|
| cellReselectionSubPriority | CellReselectionSubPriority |

| | |
|---|---|
| OPTIONAL, | -- Need R |

| | |
|---|---|
| q-OffsetFreq | Q-OffsetRange |

DEFAULT dB0,

| | |
|---|---|
| interFreqNeighCellList | InterFreqNeighCellList |

| | |
|---|---|
| OPTIONAL, | -- Need R |

| | |
|---|---|
| interFreqBlackCellList | InterFreqBlackCellList |

| | |
|---|---|
| OPTIONAL, | -- Need R |

...
}

| | |
|---|---|
| InterFreqCarrierFreqInfo-v1610 ::= | SEQUENCE { |

| | |
|---|---|
| interFreqNeighCellList-v1610 | InterFreqNeighCellList-v1610 |

| | |
|---|---|
| OPTIONAL, | -- Need R |

| | |
|---|---|
| smtc2-LP-r16 | SSB-MTC2-LP-r16 |

| | |
|---|---|
| OPTIONAL, | -- Need R |

| | |
|---|---|
| interFreqWhiteCellList-r16 | InterFreqWhiteCellList-r16 |

| | |
|---|---|
| OPTIONAL, | -- Cond SharedSpectrum2 |

| | |
|---|---|
| ssb-PositionQCL-Common-r16 | SSB-PositionQCL-Relation-r16 |

| | |
|---|---|
| OPTIONAL, | -- Cond SharedSpectrum |

| interFreqCAG-CellList-r16 | SEQUENCE (SIZE (1..maxPLMN)) OF | |
|---|---|---|
| InterFreqCAG-CellListPerPLMN-r16 | OPTIONAL | -- Need R |

}

| | |
|---|---|
| InterFreqNeighCellList ::= | SEQUENCE (SIZE (1..maxCellInter)) OF |

InterFreqNeighCellInfo

| | |
|---|---|
| InterFreqNeighCellList-v1610 ::= | SEQUENCE (SIZE (1..maxCellInter)) OF |

InterFreqNeighCellInfo-v1610

| | |
|---|---|
| InterFreqNeighCellInfo ::= | SEQUENCE { |
| physCellId | PhysCellId, |
| q-OffsetCell | Q-OffsetRange, |

| | |
|---|---|
| q-RxLevMinOffsetCell | INTEGER (1..8) |

| | |
|---|---|
| OPTIONAL, | -- Need R |

| | |
|---|---|
| q-RxLevMinOffsetCellSUL | INTEGER (1..8) |

| | |
|---|---|
| OPTIONAL, | -- Need R |

| | |
|---|---|
| q-QualMinOffsetCell | INTEGER (1..8) |

| | |
|---|---|
| OPTIONAL, | -- Need R |

...
}

| | |
|---|---|
| InterFreqNeighCellInfo-v1610 ::= | SEQUENCE { |

| | |
|---|---|
| ssb-PositionQCL-r16 | SSB-PositionQCL-Relation-r16 |

| | |
|---|---|
| OPTIONAL | -- Cond SharedSpectrum2 |

}

| | |
|---|---|
| InterFreqBlackCellList: := | SEQUENCE (SIZE (1..maxCellBlack)) OF PCI- |

Range

| | |
|---|---|
| InterFreqWhiteCellList-r16 ::= | SEQUENCE (SIZE (1..maxCellWhite)) OF PCI- |

Range
InterFreqCAG-CellListPerPLMN-r16 ::= SEQUENCE {

| | |
|---|---|
| plmn-IdentityIndex-r16 | INTEGER (1..maxPLMN), |
| cag-CellList-r16 | SEQUENCE (SIZE (1..maxCAG-Cell- |

r16)) OF PCI-Range
}

The SIB5 may include information/parameter for the UE in the RRC idle mode or in the RRC inactive state to reselect the inter-RAT frequency cell. As an example, through the SIB5, one or a plurality of evolved universal mobile telecommunications system (UMTS) terrestrial radio access (EUTRA) frequencies may be broadcasted, and one-cell reselection priority configuration information for each EUTRA frequency may be broadcasted. Although the cell reselection priority configuration information for each EUTRA frequency means the above-described contents (e.g., cellReselectionPriority and/or cellReselectionSubPriority each mapped onto the EUTRA frequency), the one-cell reselection priority configuration information for each EUTRA frequency is featured to be optionally broadcasted. Specifically, through the SIB5, information in Table 5 below may be broadcasted.

TABLE 5

| | |
|---|---|
| SIB5 ::= | SEQUENCE { |
| carrierFreqListEUTRA | CarrierFreqListEUTRA |

| | |
|---|---|
| OPTIONAL, | -- Need R |

| | |
|---|---|
| t-ReselectionEUTRA | T-Reselection, |
| t-ReselectionEUTRA-SF | SpeedStateScaleFactors |

| | |
|---|---|
| OPTIONAL, | -- Need S |

| | |
|---|---|
| lateNonCriticalExtension | OCTET STRING |

```
OPTIONAL,
  ...,
  [[
```

| | |
|---|---|
| carrierFreqListEUTRA-v1610 | CarrierFreqListEUTRA-v1610 |

| | |
|---|---|
| OPTIONAL | -- Need R |

]]
}

| | |
|---|---|
| CarrierFreqListEUTRA: := | SEQUENCE (SIZE (1..maxEUTRA-Carrier)) |

OF CarrierFreqEUTRA

| | |
|---|---|
| CarrierFreqListEUTRA-v1610 ::= | SEQUENCE (SIZE (1..maxEUTRA-Carrier)) |

OF CarrierFreqEUTRA-v1610

| | |
|---|---|
| CarrierFreqEUTRA ::= | SEQUENCE { |
| carrierFreq | ARFCN-ValueEUTRA, |
| eutra-multiBandInfoList | EUTRA-MultiBandInfoList |

| | |
|---|---|
| OPTIONAL, | -- Need R |

| | |
|---|---|
| eutra-FreqNeighCellList | EUTRA-FreqNeighCellList |

| | |
|---|---|
| OPTIONAL, | -- Need R |

| | |
|---|---|
| eutra-BlackCellList | EUTRA-FreqBlackCellList |

| | |
|---|---|
| OPTIONAL, | -- Need R |

| | |
|---|---|
| allowedMeasBandwidth | EUTRA-AllowedMeasBandwidth, |
| presenceAntennaPort1 | EUTRA-PresenceAntennaPort1, |
| cellReselectionPriority | CellReselectionPriority |

| | |
|---|---|
| OPTIONAL, | -- Need R |

| | |
|---|---|
| cellReselectionSubPriority | CellReselectionSubPriority |

| | |
|---|---|
| OPTIONAL, | -- Need R |

| | |
|---|---|
| threshX-High | ReselectionThreshold, |
| threshX-Low | ReselectionThreshold, |
| q-RxLevMin | INTEGER (−70..−22), |
| q-QualMin | INTEGER (−34..−3), |
| p-MaxEUTRA | INTEGER (−30..33), |
| threshX-Q | SEQUENCE { |
| threshX-HighQ | ReselectionThresholdQ, |
| threshX-LowQ | ReselectionThresholdQ |

}

| | |
|---|---|
| OPTIONAL | -- Cond RSRQ |

}
CarrierFreqEUTRA-v1610 ::= SEQUENCE {

| | |
|---|---|
| highSpeedEUTRACarrier-r16 | ENUMERATED {true} |

| | |
|---|---|
| OPTIONAL | -- Need R |

}

| | |
|---|---|
| EUTRA-FreqBlackCellList ::= | SEQUENCE (SIZE (1..maxEUTRA- |

CellBlack)) OF EUTRA-PhysCellIdRange

| | |
|---|---|
| EUTRA-FreqNeighCellList ::= | SEQUENCE (SIZE (1..maxCellEUTRA)) |

OF EUTRA-FreqNeighCellInfo

| | |
|---|---|
| EUTRA-FreqNeighCellInfo ::= | SEQUENCE { |
| physCellId | EUTRA-PhysCellId, |
| dummy | EUTRA-Q-OffsetRange, |
| q-RxLevMinOffsetCell | INTEGER (1..8) |

| | |
|---|---|
| OPTIONAL, | -- Need R |

| | |
|---|---|
| q-QualMinOffsetCell | INTEGER (1..8) |

| | |
|---|---|
| OPTIONAL | -- Need R |

}

The UE in the RRC idle mode or in the RRC inactive state may perform a cell reselection evaluation procedure. The cell reselection evaluation procedure may mean a series of processes of reselecting the cell by handling reselection priorities, performing frequency measurement through application of measurement rules for cell reselection, and evaluating the cell reselection criteria.

At 1e-25, the UE in the RRC idle mode or in the RRC inactive state may determine the reselection priorities based on the system information received at 1e-20. The UE can determine the reselection priorities only with respect to the frequency at which the cell reselection priority value is broadcasted based on the system information. Based on the cell reselection priority value mapped onto the NR frequency to which the currently camped-on serving cell belongs, the UE may determine whether the cell reselection priority for each NR inter-frequency or inter-RAT frequency is the same cell reselection priority as that of the NR frequency to which the serving cell belongs, whether the cell reselection priority is higher than the cell reselection priority of the NR frequency to which the serving cell belongs, or whether the cell reselection priority is lower than the cell reselection priority of the NR frequency to which the serving cell belongs.

As an example, in case that, in the system information obtained at 1e-20, the cell reselection priority value mapped onto the NR frequency to which the currently camped-on serving cell belongs is 3, the cell reselection priority value of inter NR frequency 1 is 2, the cell reselection priority value of inter NR frequency 2 is 3, the cell reselection priority value of inter NR frequency 3 is 4, and the cell reselection priority value of EUTRA frequency 1 is 2, the UE may determine the inter NR frequency 1 and the EUTRA frequency 1 as a lower reselection priority, determine the cell reselection priority of the inter NR frequency 2 as an equal reselection priority, and determine the cell reselection priority of the inter NR frequency 3 as a higher reselection priority.

At 1e-30, the UE in the RRC idle mode or in the RRC inactive state may perform the frequency measurement for the cell reselection. In this case, in order to minimize the battery consumption, the UE may perform the frequency measurement by using the following measurement rule in accordance with the cell reselection priority determined at 1e-25.
If the following Condition 1 is satisfied, the UE may not perform the NR intra-frequency measurement. Otherwise (e.g., if the following Condition 1 is not satisfied), the UE may perform the NR intra-frequency measurement.

Condition 1: The reception level (Srxlev) of the serving cell is larger than the SIntraSearchP threshold value, and the reception quality (Squal) of the serving cell is larger than the SIntraSearchQ threshold value (Serving cell fulfills Srxlev>SIntraSearchP and Squal>SIntraSearchQ).
With respect to the NR inter-frequency or inter-RAT frequency having a higher reselection priority than that of the NR frequency of the current serving cell, the UE may perform the measurement in accordance with the 3GPP TS 38.133 standard.
With respect to the NR inter-frequency having the reselection priority that is lower than or equal to that of the NR frequency of the current serving cell and the inter-RAT frequency having the reselection priority that is lower than that of the NR frequency of the current serving cell, the UE may not perform the measurement if the following Condition 2 is satisfied. Otherwise (e.g., if the following Condition 2 is not satisfied), the UE may measure the cells which are at the NR inter-frequency having the reselection priority that is equal to or lower than that of the NR frequency, or may measure the cells which are at the inter-RAT frequency having the reselection priority that is lower than that of the NR frequency.

Condition 2: The reception level (Srxlev) of the serving cell is larger than the SnonIntraSearchP threshold value, and the reception quality (Squal) of the serving cell is larger than the SnonIntraSearchQ threshold value (Serving cell fulfills Srxlev>SnonIntraSearchP and Squal>SnonIntraSearchQ).

For reference, the above-described threshold values (SintraSearchP, SintraSearchQ, SnonIntraSearchP, and SnonintraSearchQ) may be broadcasted from the system information obtained at 1e-20.

At 1e-35, the UE in the RRC idle mode or in the RRC inactive state may determine to reselect the cell that satisfies the cell reselection criteria based on the measurement value performed at 1e-30. The cell reselection criteria may differ in accordance with the cell reselection priority. Cell reselection to a higher priority RAT/frequency may take precedence over a lower priority RAT/frequency if multiple cells of different priorities fulfill the cell reselection criteria. Specifically, with respect to the reselection criteria of the inter-frequency/inter-RAT cell having a higher priority than the priority of the frequency of the current serving cell, the UE operation may be as follows.

First Operation:

In case that the threshold value for threshServingLowQ is included in the SIB2 being broadcasted, and one second has passed since the UE camps on the current serving cell, if the signal quality (Squal) of the inter-frequency/inter-RAT cell is higher than the threshold value Thresh_{X,HighQ} during a specific time interval Treselection_{RAT} (Squal>Thresh_{X,HighQ} during a time interval Treselection_{RAT}), the UE may perform the reselection to the corresponding inter-frequency/inter-RAT cell.

Second Operation:

If the UE is unable to perform the first operation, it may perform a second operation.

In case that one second has passed since the UE camps on the current serving cell, and the reception level (Srxlev) of the inter-frequency/inter-RAT cell is larger than the threshold value Thresh_{X,HighP} during a specific time interval Treselection_{RAT} (Srxlev>Thresh_{X,HighP} during a time interval Treselection_{RAT}), the UE may perform the reselection to the corresponding inter-frequency/inter-RAT cell.

Here, the UE may perform the first operation or the second operation based on information about the inter-frequency cell signal quality (Squal), reception level (Srxlev), threshold values (Thresh_{X, HighQ} and Thresh_{X, HighP}), and Treselection_{RAT} values included in the SIB4 being broadcasted in the serving cell, and may perform the first operation or the second operation based on information about the inter-RAT cell signal quality (Squal), reception level (Srxlev), threshold values (Thresh_{X,HighQ} and Thresh_{X, HighP}), and Treselection_{RAT} values included in the SIB5 being broadcasted in the serving cell. As an example, Q_{qualmin} value or Qᵣₓₗₑᵥₘᵢₙ value may be included in the SIB4, and based on this, the inter-frequency cell signal quality (Squal) or reception level (Srxlev) may be derived. In case that a plurality of cells exist in the NR frequency that satisfies a higher cell reselection priority, the UE may reselect the highest ranked cell among the cells that satisfy the reselection criteria of the intra-frequency/inter-frequency cell having the same priority as that of the frequency of the current serving cell to be described below.

Further, with respect to the reselection criteria of the intra-frequency/inter-frequency cell having the same priority as that of the frequency of the current serving cell, the UE operation may be as follows.

Third Operation:

In case that the signal quality (Squal) and the reception level (Srxlev) of the intra-frequency/inter-frequency cell are larger than 0, the UE derives ranking of each cell based on the measurement value (RSRP) (the UE performs ranking of all cells that fulfill the cell selection criterion S). The ranking of the serving cell and the neighboring cell is calculated through Equation (2) below.

Rₛ=Q_{meas,s}+Q_{hyst}

Rₙ=Q_{meas,n}−Q_{offset} (2)

Here, Q_{meas,s} represents an RSRP measurement value of the serving cell, Q_{meas,n} represents an RSRP measurement value of the neighboring cell, Q_{hyst} represents the hysteresis value of the serving cell, and Qoffset represents an offset between the serving cell and the neighboring cell. The SIB2 includes the Q_{hyst} value, and the corresponding value may be commonly used for the reselection of the intra-frequency/inter-frequency cell. In case of the reselection of the intra-frequency cell, Qoffset may be signaled for each cell, may be applied to the indicated cell only, and may be included in the SIB3. In case of the reselection of the inter-frequency cell, the Qoffset may be signaled for each cell, may be applied to the indicated cell only, and may be included in the SIB4. In case that the rank of the neighboring cell that is obtained from mathematical expression 2 is higher than the rank of the serving cell (Rₙ>Rₛ), the optimum cell among the neighboring cells may be re-selected.

Further, with respect to the reselection criteria of the inter-frequency/inter-RAT cell having the priority that is lower than the priority of the frequency of the current serving cell, the UE operation may be as follows.

Fourth Operation:

In case that the threshold value for threshServingLowQ is included in the SIB2 being broadcasted, and one second has passed since the UE camps on the current serving cell, if the signal quality (Squal) of the current serving cell is lower than the threshold value Thresh_{Serving, LowQ} (Squal<Thresh_{Serving, LowQ}) and the signal quality (Squal) of the inter-frequency/inter-RAT cell is higher than the threshold value Thresh_{X, LowQ} during a specific time interval Treselection_{RAT} (Squal>Thresh_{X,LowQ} during a time interval Treselection_{RAT}), the UE may perform the reselection to the corresponding inter-frequency/inter-RAT cell.

Fifth Operation:

If the UE is unable to perform the fourth operation, it may perform a fifth operation.

In case that one second has passed since the UE camps on the current serving cell, and the reception level (Srxlev) of the current serving cell is lower than the threshold value Thresh_{Serving, LowP} (Srxlev<Thresh_{Serving, LowP}) and the reception level (Srxlev) of the inter-frequency/inter-RAT cell is higher than the threshold value Thresh_{X, LowQ} during a specific time interval Treselection_{RAT} (Srxlev>Thresh_{X,LowP} during a time interval Treselection_{RAT}), the UE may perform the reselection to the corresponding inter-frequency/inter-RAT cell.

Here, the fourth operation or the fifth operation for the inter-frequency cell of the UE may be performed based on threshold values (Thresh_{Serving, LowQ}, Thresh_{Serving, LowP}) included in the SIB2 being broadcasted in the serving cell, and the signal quality (Squal) of the inter-frequency cell included in the SIB4 being broadcasted in the serving cell, reception level (Srxlev), threshold values (Thresh_{X, LowQ}, Thresh_{X, LowP}), and Treselection_{RAT}, and the fourth operation or the fifth operation for the inter-RAT cell of the UE may be performed based on threshold values (Thresh_{Serving, LowQ}, Thresh_{Serving, LowP}) included in the SIB2 being broadcasted in the serving cell, and the signal quality (Squal) of the inter-RAT cell included in the SIB5 being broadcasted in the serving cell, reception level (Srxlev), threshold values (Thresh_{X, LowQ}, Thresh_{X, LowP}), and Treselection_{RAT}. As an example, Q_{qualmin} value or Qᵣₓₗₑᵥₘᵢₙ value may be included in the SIB4, and based on this, the inter-frequency cell signal quality (Squal) or reception level (Srxlev) may be derived. In case that a plurality of cells exist in the NR frequency that satisfies a higher cell reselection priority, the UE may reselect the highest ranked cell among the cells that satisfy the reselection criteria of the intra-frequency/inter-frequency cell having the same priority as that of the frequency of the current serving cell to be described below.

At 1e-40, the UE in the RRC idle mode or in the RRC inactive state may receive the system information (e.g., MIB or SIB1) being broadcasted in a candidate target cell before finally reselecting the candidate target cell, and may determine whether the reception level (Srxlev) and the reception quality (Squal) of the candidate target cell satisfy the cell selection criterion that is called S-criterion (mathematical expression 1) (Srxlev>0 and Squal>0) based on the received system information. In case that the mathematical expression 1 is satisfied and the candidate target cell is suitable, the UE may reselect the candidate target cell.

The features of the NR cell and the UE may be defined as follows:

1. The currently camped-on serving cell is featured to mandatorily broadcast the cell reselection priority value mapped onto the NR frequency to which the serving cell belongs as the system information.

2. In case that the UE in the RRC idle mode or in the RRC inactive state manages the cell reselection priorities (handles the reselection priorities) based on the system information, the UE may determine whether the cell reselection priority for each NR inter-frequency or inter-RAT frequency is the same cell reselection priority as that of the NR frequency to which the serving cell belongs, whether the cell reselection priority is higher than the cell reselection priority of the NR frequency to which the serving cell belongs, or whether the cell reselection priority is lower than the cell reselection priority of the NR frequency to which the serving cell belongs based on the cell reselection priority value mapped onto the NR frequency to which the serving cell belongs.

3. The UE in the RRC idle mode or in the RRC inactive state may determine whether to measure the NR intra-frequency by comparing the signal strength and the signal quality of the currently camped-on serving cell with the threshold values.

FIG. 1F is a diagram illustrating a procedure in which a UE in an RRC_IDLE mode or in an RRC_INACTIVE state performs a slice-based cell reselection evaluation procedure by applying slice-based cell reselection priority information, being broadcasted from system information in a next generation mobile communication system, according to an embodiment of the disclosure.

Herein, the serving cell on which the UE in the RRC_IDLE mode or in the RRC_INACTIVE state camps is featured to be able to broadcast supportable single-network slice selection assistance information (S-NSSAI) (hereinafter, slice) or an S-NSSAI list (hereinafter, slice group) for each NR frequency or for one or a plurality of neighboring cells operating in each NR frequency through the system information. For reference, through the system information, it is possible to broadcast the slice/service type (SST) or the SST and the SST and slice differentiator (SST-SD) in order to represent each slice, or to broadcast an index representing a specific S-NSSAI. Through the system information, it is possible to broadcast a list of the SST or the SST and the SST-SD in order to represent each slice group, or to broadcast an index representing a specific slice group. The UE NAS layer or upper layer may provide the slice index or the slice group index to the UE AS layer through NAS signaling or UE implementation.

Herein, the serving cell on which the UE in the RRC idle mode or in the RRC inactive state camps is featured to be able to broadcast slice cell reselection priority configuration information mapped onto the slice or the slice group for each NR frequency through the system information. That is, the serving cell may independently broadcast the above-described cell reselection priority configuration information as the slice cell reselection priority configuration information.

Herein, the UE in the RRC idle mode or in the RRC inactive state may support all of the above-described cell reselection evaluation procedure (FIG. 1E) and the slice-based cell reselection evaluation procedure. The slice-based cell reselection evaluation procedure may briefly mean the following series of processes.
Step 0: NAS layer at UE provides slice information to AS layer at UE, including slice priority (priorities) for each slice or each slice group.
Step 1: AS sorts slice(s) or slice group(s) in priority order starting with highest priority slice(s) or slice group(s).
Step 2: Select slice(s) or slice group(s) in priority order starting with the highest priority slice(s) or slice group(s).
Step 3: For the selected slice(s) or slice group(s) assign priority to frequencies received from network.
Step 4: Perform modified measurements or starting from the highest priority frequency (frequencies), perform modified measurement.
Step 5: If the highest ranked cell is determined according to cell reselection criteria (e.g., FIG. 1E) and suitable and supports the selected slice in step 2, then camp on the cell and exit this sequence of operations.
Step 6: If there are remaining frequencies, then go back to step 4.
Step 7: If the end of the slice list has not been reached, go back to step 2.
Step 8: Perform legacy cell reselection.

Note that UE may not need to perform step 6 and/or step 7. Also, step 1 and step 2 can be simplified as “select the highest priority slice(s) or slice group(s)”.

With reference to FIG. 1F, the UE 1f-01 may be in an RRC_IDLE mode or in an RRC_INACTIVE state (1f-05).

At 1f-13, the UE in the RRC idle mode or in the RRC inactive state may obtain the essential system information from an NR cell 1f-02. Herein, a MIB and a SIB1 may be referred to as the essential system information.

At 1f-15, the UE in the RRC idle mode or in the RRC inactive state may perform the cell selection procedure based on the essential system information obtained at 1f-13. The cell selection procedure is the same as that described above. That is, the UE may perform the cell selection procedure as described above without considering whether to support the slice or the slice group.

At 1f-20, the UE in the RRC idle mode or in the RRC inactive state may obtain the system information (e.g., SIB2, SIB3, SIB4, SIB5, or new SIB) that contains the cell reselection information from the serving cell 1f-02 in order to perform the cell reselection evaluation procedure of described above (FIG. 1E) and/or to perform the slice-based cell reselection evaluation procedure. The cell reselection information for the cell reselection evaluation procedure being broadcasted from the system information may follow the description of FIG. 1E. The disclosure provides that new cell reselection information for the slice-based cell reselection evaluation procedure is additionally included in the system information.

Specifically,
SIB2: This may broadcast a slice (indicator) or a slice group (indicator) that is supportable at the serving NR frequency. Further, the slice-based cell reselection priority configuration information may be selectively included in the SIB2. As an example, the slice-based cell reselection priority configuration information may means cellReselectionPriorityForSlice and cellReselectionSubPriorityForSlice, and the cellReselectionPriorityForSlice value may represent an integer value as described above, and the cellReselectionSubPriorityForSlice value may represent a decimal value as described above.

In case that a slice (indicator) or a slice group (indicator) being supportable at the serving NR frequency is broadcasted, the SIB2 may include an indicator indicating that the slice (or slice indicator) or the slice group (or slice group indicator) that is additionally supported at the serving NR frequency can be supported by all neighboring cells operating at the serving NR frequency. Further, in order to indicate that all neighboring cells operating at the serving NR frequency are supportable, the serving NR frequency may not include a neighboring cell list.

The UE may perform the slice cell reselection evaluation procedure in consideration of all the neighboring cells existing at the serving NR frequency. In case that only specific neighboring cells among all the neighboring cells operating at the serving NR frequency support the slice (indicator) or the slice group (indicator), the neighboring cell list for representing this may be broadcasted through the SIB2. The UE may perform the slice cell reselection evaluation procedure in consideration of only the neighboring cell list broadcasted at the serving NR frequency. Of course, the neighboring cell list that does not support the slice (indicator) or the slice group (indicator) may be broadcasted through the SIB2.

The UE may perform the slice cell reselection evaluation procedure for the neighboring cells excluding the neighboring cell list broadcasted at the serving NR frequency. For reference, the above-described contents may be applied for each PLMN and/or slice (indicator) or slice group (indicator).
SIB3: This may broadcast a slice (indicator) or a slice group (indicator) that is supportable at the serving NR frequency. Further, the slice-based cell reselection priority configuration information may be selectively included in the SIB3.

In case that a slice (indicator) or a slice group (indicator) being supportable at the serving NR frequency is broadcasted, the SIB3 may include an indicator indicating that the slice (indicator) or the slice group (indicator) that is additionally supported at the serving NR frequency can be supported by all neighboring cells operating at the serving NR frequency. Further, in order to indicate that all neighboring cells operating at the serving NR frequency are supportable, the serving NR frequency may not include a neighboring cell list. The UE may perform the slice cell reselection evaluation procedure in consideration of all the neighboring cells existing at the serving NR frequency.

In case that only a specific one or a plurality of neighboring cells additionally support the slice (indicator) or the slice group (indicator) at the serving NR frequency, the SIB3 may broadcast the corresponding neighboring cell list. The UE may perform the slice cell reselection evaluation procedure in consideration of only the neighboring cell list broadcasted at the serving NR frequency. When the serving cell broadcasts the SIB3, the neighboring cell list may be broadcasted as a PCI list, or an identifier for each cell may be broadcasted as an index in order to represent the neighboring cell for signaling optimization.

As an example, the index may mean representation of a specific order existing in the neighboring cell list (e.g., intraFreqNeighCellList or intraFreqWhiteCellList or intraFreqBlackCellList) included in the SIB3 in the related art. Of course, the corresponding neighboring cell list that does not support the slice (indicator) or the slice group (indicator) may be broadcasted. The UE may perform the slice cell reselection evaluation procedure for the neighboring cells excluding the neighboring cell list broadcasted at the serving NR frequency. When the serving cell broadcasts the SIB3, the neighboring cell list may be broadcasted as the PCI list, or the identifier for each cell may be broadcasted as the index in order to represent the neighboring cell for the signaling optimization. As an example, the index may mean representation of the specific order existing in the neighboring cell list (e.g., intraFreqNeighCellList or intraFreqWhiteCellList or intraFreqBlackCellList) included in the SIB3 in the related art. For reference, the above-described contents may be applied for each PLMN and/or slice (indicator) or slice group (indicator).
SIB4: This may broadcast the slice (indicator) or the slice group (indicator) that is supportable for each NR inter-frequency. Further, the slice-based cell reselection priority configuration information mapped onto each NR inter-frequency may be selectively included in the SIB4.

In case that the slice (indicator) or the slice group (indicator) being supportable at the specific NR inter-frequency is broadcasted, an indicator indicating that the slice (indicator) or the slice group (indicator) can be supported by all neighboring cells operating at the corresponding NR inter-frequency may be included, or the neighboring cell list operating at the corresponding NR inter-frequency may not be included in order to represent that the slice (indicator) or the slice group (indicator) can be supported by the all neighboring cells operating at the corresponding NR inter-frequency. The UE may perform the slice cell reselection evaluation procedure in consideration of all the neighboring cells existing at the corresponding NR inter-frequency.

In case that the slice (indicator) or the slice group (indicator) that can be supported at the NR inter-frequency is broadcasted, and only a specific one or a plurality of neighboring cells operating at the corresponding NR inter-frequency support the slice (indicator) or the slice group (indicator), the SIB4 may include the one or the plurality of neighboring cells. The UE may perform the slice cell reselection evaluation procedure in consideration of only the neighboring cell list broadcasted at the corresponding NR inter-frequency. When the serving cell broadcasts the SIB4, the neighboring cell list may be broadcasted as a PCI list, or an identifier for each cell may be broadcasted as an index in order to represent the neighboring cell for signaling optimization. As an example, the index may mean representation of a specific order existing in the neighboring cell list (e.g., intraFreqNeighCellList or intraFreqWhiteCellList or intraFreqBlackCellList) included in the SIB4 in the related art. Of course, the corresponding neighboring cell that does not support the slice (indicator) or the slice group (indicator) may be broadcasted. The UE may perform the slice cell reselection evaluation procedure for the neighboring cells excluding the neighboring cell list broadcasted at the corresponding NR inter-frequency. When the serving cell broadcasts the SIB4, the neighboring cell list may be broadcasted as the PCI list, or the identifier for each cell may be broadcasted as the index in order to represent the neighboring cell for the signaling optimization. As an example, the index may mean representation of the specific order existing in the neighboring cell list (e.g., intraFreqNeighCellList or intraFreqWhiteCellList or intraFreqBlackCellList) included in the SIB3 in the related art. For reference, the above-described contents may be applied for each PLMN and/or slice (indicator) or slice group (indicator).
New SIB: The contents described above through SIB2/3/4 may be broadcasted through a new SIB.

At 1f-25, the UE in the RRC idle mode or in the RRC inactive state, which supports the slice-based cell reselection evaluation procedure, may perform the following procedure.
Step 0: NAS layer at UE provides slice information to AS layer at UE, including slice priority (priorities) per each slice or each slice group.
Step 1: AS sorts slice(s) or slice group(s) in priority order starting with highest priority slice(s) or slice group(s).
Step 2: Select slice(s) or slice group(s) in priority order starting with the highest priority slice(s) or slice group(s).

For reference, the UE may not perform Step 1 and Step 2, but may perform selection of the highest priority slice(s) or slice group(s).

The UE in the RRC idle mode or in the RRC inactive state, which supports the slice-based cell reselection evaluation procedure, may perform the slice-based cell reselection evaluation procedure in case that the slice (or slice group) information selected at 1f-25 is broadcasted based on the system information received at 1f-20.

The slice-based cell reselection evaluation procedure may mean a series of processes of reselecting the cell that supports the slice or the slice group selected at 1f-25 by determining slice-based reselection priorities, performing frequency measurement through application of the measurement rules for the slice-based cell reselection, and evaluating the cell reselection criteria described above. For reference, the UE in the RRC idle mode or in the RRC inactive state, which supports the slice-based cell reselection evaluation procedure, may perform the cell reselection evaluation procedure described above in case that the slice (or slice group) information selected at 1f-25 is not broadcasted based on the system information received at 1f-20.

At 1f-30, the UE in the RRC idle mode or in the RRC inactive state, which supports the slice-based cell reselection evaluation procedure, may determine the slice-based reselection priorities based on the system information received at 1f-20. The UE can determine the slice-based reselection priorities only with respect to the frequency at which the slice-based cell reselection priority value mapped onto the slice (or slice group) selected at 1f-25 is broadcasted based on the system information.

Unlike the above-described embodiment, the serving NR frequency at which the serving cell operates may not support the slice or slice group selected by the UE. For example, the serving NR frequency at which the serving cell operates may not support the slice (or slice group) itself or the slice (or slice group) selected by the UE, and thus may not broadcast the slice reselection priority value mapped onto the slice or the slice group selected by the UE. Accordingly, it may not be possible to determine the slice-based reselection priorities for each NR inter-frequency based on the slice-based reselection priority value mapped onto the serving NR frequency to which the serving cell belongs. The UE in the RRC idle mode or in the RRC inactive state, which supports the slice-based cell reselection evaluation procedure, may be disclosed to apply one of the following operations in case that the slice (or slice group) selected by the UE through the system information received at 1f-20 is not supported at the serving NR frequency (or the slice reselection priority value mapped onto the NR frequency is not broadcasted with respect to the slice (or slice group) selected by the UE), and the slice reselection priority value mapped onto the slice (or slice group) selected by the UE in at least one NR inter-frequency is broadcasted. For reference, the slice reselection priorities are called the reselection priorities mapped onto the NR frequency.

Operation 1: The UE may apply the slice reselection priority value received from the system information for each NR inter-frequency that supports the slice or the slice group selected by the UE. Further, the UE may determine each NR inter-frequency to which the slice reselection priority value is applied as a higher slice reselection priority. The higher slice reselection priority may mean the slice reselection priority that is higher than that of the serving NR frequency.

Operation 2: The UE may apply the slice reselection priority value received from the system information for each NR inter-frequency that supports the slice or the slice group selected by the UE. The UE may apply the slice reselection priority of the serving NR frequency as a lower priority than the slice reselection priority value received from the system information for each NR inter-frequency or as the lowest slice reselection priority value. Accordingly, the UE may determine each NR inter-frequency to which the slice reselection priority value is applied with a higher slice reselection priority.

Operation 3: The UE may apply the slice reselection priority value received from the system information for each NR inter-frequency that supports the slice or the slice group selected by the UE. The UE may apply the reselection priority value mapped onto the serving frequency (reselection priority value mapped onto the serving frequency of FIG. 1E) as the slice reselection priority value. The UE may determine the slice reselection priority for each NR inter-frequency through comparison of whether the applied slice reselection priority value for each NR inter-frequency is larger than, equal to, or smaller than the slice reselection priority value of the serving frequency based on the slice reselection priority value applied to the serving frequency.

Operation 4: The UE may apply the slice reselection priority value received from the system information for each NR inter-frequency that supports the slice or the slice group selected by the UE. The UE may apply the reselection priority value mapped onto the serving frequency (reselection priority value mapped onto the serving frequency of FIG. 1E) as the slice reselection priority value. Other than the slice or slice group selected by the UE, the UE may apply, to the serving NR frequency, the smallest slice reselection priority value, the largest slice reselection priority value, or a specific slice reselection priority value among the slice reselection priority values mapped onto the slice or slice group being supported at the serving NR frequency. The UE may determine the slice reselection priority for each NR inter-frequency through comparison of whether the applied slice reselection priority value for each NR inter-frequency is larger than, equal to, or smaller than the slice reselection priority value of the serving frequency based on the slice reselection priority value applied to the serving frequency.

Operation 5: The UE may apply the slice reselection priority value received from the system information for each NR inter-frequency that supports the slice or the slice group selected by the UE. The UE may apply the slice reselection priority value for the NR serving frequency as 0. Accordingly, the UE may determine each NR inter-frequency to which the slice reselection priority value is applied with a higher slice reselection priority.

At 1f-35, the UE in the RRC idle mode or in the RRC inactive state, which supports the slice-based cell reselection evaluation procedure, may perform the frequency measurement in order to reselect the cell that supports the slice or the slice group selected by the UE. The UE is provided to perform the frequency measurement by using the following measurement rule. For reference, the UE is featured to perform the measurement only with respect to the frequency that supports the slice or the slice group selected by the UE. Of course, the measurement may be performed with respect to the inter-RAT frequency described above (FIG. 1E). For reference, the following measurement rule may be applied even to a case where the cell slice-based reselection priority is determined based on an RRC connection release message.
If the slice or the slice group selected by the UE is not supported at the NR serving frequency, or if the slice reselection priority is not applied to the NR serving frequency, the NR intra-frequency measurement may not be performed.
If the slice or the slice group selected by the UE is supported at the NR serving frequency, or if the UE applies the slice reselection priority to the NR serving frequency, the UE may not perform the NR intra-frequency measurement in case that the following Condition 1 is satisfied. Otherwise (e.g., in case that the following Condition 1 is not satisfied), the UE may perform the NR intra-frequency measurement.

Condition 1: The reception level (Srxlev) of the serving cell is larger than the SIntraSearchP threshold value, and the reception quality (Squal) of the serving cell is larger than the SIntraSearchQ threshold value (Serving cell fulfills Srxlev>SIntraSearchP and Squal>SIntraSearchQ).
In case that an indicator indicating to measure the NR serving cell that does not support the slice or the slice group selected by the UE is broadcasted through the system information, the UE may measure the NR serving frequency as described above.
With respect to the NR inter-frequency or inter-RAT frequency having a higher slice reselection priority than that of the NR frequency of the current serving cell, the UE may perform the measurement in accordance with the 3GPP TS 38.133 standard.
With respect to the NR inter-frequency having the slice reselection priority that is equal to or lower than that of the NR frequency of the current serving cell, the UE may not perform the measurement if the following Condition 2 is satisfied. Otherwise (e.g., if the following Condition 2 is not satisfied), the UE may measure the cells which are at the NR inter-frequency having the slice reselection priority that is equal to or lower than that of the NR frequency.

Condition 2: The reception level (Srxlev) of the serving cell is larger than the SnonIntraSearchP threshold value, and the reception quality (Squal) of the serving cell is larger than the SnonIntraSearchQ threshold value (Serving cell fulfills Srxlev>SnonIntraSearchP and Squal>SnonIntraSearchQ).

For reference, the above-described threshold values (SintraSearchP, SintraSearchQ, SnonIntraSearchP, and SnonintraSearchQ) may be broadcasted from the system information obtained at 1f-20.

At 1f-40, the UE in the RRC idle mode or in the RRC inactive state may determine to reselect the cell that satisfies the cell reselection criteria based on the measurement value performed at 1f-35. The above-described embodiment may be followed based on the slice reselection priorities.

At 1f-45, the UE in the RRC idle mode or in the RRC inactive state receives the system information (e.g., MIB or SIB1) being broadcasted in a candidate target cell before finally reselecting the corresponding cell, and may determine whether the reception level (Srxlev) and the reception quality (Squal) of the target cell satisfy the cell selection criterion that is called S-criterion (mathematical expression 1) (Srxlev>0 and Squal>0) based on the received system information. In case that the mathematical expression 1 is satisfied and the candidate target cell is suitable and supports the slice or the slice group selected by the UE, the UE may reselect the corresponding cell.

For reference, in case that the frequency that supports the slice or the slice group selected by the UE is not in the system information received at 1f-20, the UE may perform the cell reselection evaluation procedure as described above. Further, in case that the cell that supports the slice or the slice group selected by the UE is unable to be reselected although the slice-based cell reselection evaluation procedure is performed, the UE may perform the cell reselection evaluation procedure as described above.

The features of the NR cell and the UE may be defined as follows:

1. The currently camped-on serving cell or the serving NR frequency is featured not to mandatorily broadcast the slice cell reselection priority value mapped onto the slice (or slice group) selected by the UE as the system information.

2. The UE in the RRC idle mode or in the RRC inactive state, which supports the slice-based cell reselection evaluation procedure, may determine the slice-based cell reselection priorities based on the system information. In case that the serving NR frequency does not support the slice or the slice group selected by the UE, or the slice-based cell reselection priority value mapped onto the slice or the slice group selected by the UE in at least one NR inter-frequency is broadcasted from the system information in a state where the slice-based cell reselection priority value mapped onto the serving NR frequency does not exist in the slice or the slice group selected by the UE, the UE may determine the serving NR frequency with the lowest reselection priority, or may determine each NR inter-frequency supporting the slice or the slice group selected by the UE with a higher reselection priority. If the serving NR frequency supports the slice or the slice group selected by the UE, the UE may determine the reselection priority for each NR inter-frequency that supports the slice or the slice group selected by the UE based on the serving NR frequency (slice-based reselection priority value) in the same manner described above.

FIG. 1G is a block diagram illustrating the internal structure of a UE, according to an embodiment.

With reference to the drawing, the UE includes a radio frequency (RF) processor 1g-10, a baseband processor 1g-20, a storage unit 1g-30, and a controller 1g-40.

The RF processor 1g-10 performs a function for transmitting and receiving a signal on a radio channel, such as signal band conversion and amplification. That is, the RF processor 1g-10 performs up-conversion of a baseband signal provided from the baseband processor 1g-20 into an RF-band signal to transmit the converted signal through an antenna, and performs down-conversion of the RF-band signal received through the antenna into a baseband signal. For example, the RF processor 1g-10 may include a transmission filter, a reception filter, an amplifier, a mixer, an oscillator, a digital-to-analog converter (DAC), and an analog-to-digital converter (ADC). Although only one antenna is illustrated in the drawing, the UE may be provided with a plurality of antennas. Further, the RF processor 1g-10 may include a plurality of RF chains. Further, the RF processor 1g-10 may perform beamforming. For the beamforming, the RF processor 1g-10 may adjust phases and sizes of signals transmitted or received through the plurality of antennas or antenna elements. Further, the RF processor 1g-10 may perform MIMO, and may receive several layers during performing of the MIMO operation.

The baseband processor 1g-20 performs a conversion function between a baseband signal and a bit string in accordance with the physical layer standard of the system. For example, during data transmission, the baseband processor 1g-20 generates complex symbols by encoding and modulating a transmitted bit string. Further, during data reception, the baseband processor 1g-20 restores a received bit string by demodulating and decoding the baseband signal provided from the RF processor 1g-10. For example, in case of following an OFDM method, during data transmission, the baseband processor 1g-20 generates complex symbols by encoding and modulating a transmitted bit string, performs mapping of the complex symbols onto subcarriers, and then configures OFDM symbols through the inverse fast Fourier transform (IFFT) operation and cyclic prefix (CP) insertion. Further, during data reception, the baseband processor 1g-20 divides the baseband signal being provided from the RF processor 1g-10 in the unit of OFDM symbols, restores the signals mapped onto the subcarriers through the fast Fourier transform (FFT), and then restores the received bit string through demodulation and decoding.

The baseband processor 1g-20 and the RF processor 1g-10 transmit and receive the signals as described above. Accordingly, the baseband processor 1g-20 and the RF processor 1g-10 may be called a transmitter, a receiver, a transceiver, or a communication unit. Further, in order to support different RATs, at least one of the baseband processor 1g-20 and the RF processor 1g-10 may include a plurality of communication modules. Further, in order to process signals of different frequency bands, at least one of the baseband processor 1g-20 and the RF processor 1g-10 may include different communication modules. For example, the different RATs may include a wireless LAN (e.g., IEEE 802.11) and a cellular network (e.g., LTE). Further, the different frequency bands may include super high frequency (SHF) (e.g., 2.NR Hz or NR Hz) band and millimeter (mm) wave (e.g., 60 GHz) band.

The storage unit 1g-30 stores therein a basic program for an operation of the UE, application programs, and data of configuration information. In particular, the storage unit 1g-30 may store information related to a second access node that performs wireless communication by using a second radio access technology. Further, the storage unit 1g-30 provides stored data in accordance with a request from the controller 1g-40.

The controller 1g-40 controls the overall operations of the UE. For example, the controller 1g-40 transmits and receives signals through the baseband processor 1g-20 and the RF processor 1g-10. Further, the controller 1g-40 records or reads data in or from the storage unit 1g-30. For this, the controller 1g-40 may include at least one processor. For example, the controller 1g-40 may include a communication processor (CP) that performs a control for communication and an application processor (AP) that controls an upper layer, such as an application program. The controller 1g-40 may further include a multi-connection processor 1g-42 for multi-connection.

FIG. 1H is a block diagram illustrating the constitution of an NR base station, according to an embodiment.

The base station is configured to include an RF processor 1h-10, a baseband processor 1h-20, a backhaul communication unit 1h-30, a storage unit 1h-40, and a controller 1h-50. The RF processor 1h-10 performs a function for transmitting and receiving signals on a radio channel, such as signal band conversion and amplification. That is, the RF processor 1h-10 performs up-conversion of a baseband signal provided from the baseband processor 1h-20 into an RF-band signal to transmit the converted signal through an antenna, and performs down-conversion of the RF-band signal received through the antenna into a baseband signal. For example, the RF processor 1h-10 may include a transmission filter, a reception filter, an amplifier, a mixer, an oscillator, a DAC, and an ADC. Although only one antenna is illustrated in the drawing, the base station may be provided with a plurality of antennas. Further, the RF processor 1h-10 may include a plurality of RF chains. Further, the RF processor 1h-10 may perform beamforming. For the beamforming, the RF processor 1h-10 may adjust phases and sizes of signals being transmitted or received through the plurality of antennas or antenna elements. The RF processor may perform a downward MIMO operation through transmission of one or more layers.

The baseband processor 1h-20 performs a conversion function between a baseband signal and a bit string in accordance with the physical layer standard of the first RAT. For example, during data transmission, the baseband processor 1h-20 generates complex symbols by encoding and modulating a transmitted bit string. Further, during data reception, the baseband processor 1h-20 restores a received bit string by demodulating and decoding the baseband signal provided from the RF processor 1h-10. For example, in case of following an OFDM method, during data transmission, the baseband processor 1h-20 generates complex symbols by encoding and modulating a transmitted bit string, performs mapping of the complex symbols to subcarriers, and then configures OFDM symbols through the IFFT operation and CP insertion. Further, during data reception, the baseband processor 1h-20 divides the baseband signal provided from the RF processor 1h-10 in the unit of OFDM symbols, restores the signals mapped to the subcarriers through the FFT operation, and then restores the received bit string through demodulation and decoding. The baseband processor 1h-20 and the RF processor 1h-10 transmit and receive the signals as described above. Accordingly, the baseband processor 1h-20 and the RF processor 1h-10 may be called a transmitter, a receiver, a transceiver, a communication unit, or a wireless communication unit.

The backhaul communication unit 1h-30 provides an interface for performing communication with other nodes in the network. That is, the backhaul communication unit 1h-30 converts a bit string being transmitted from the primary base station to other nodes, for example, an auxiliary base station and a core network, into a physical signal, and converts the physical signal being received from other nodes into a bit string.

The storage unit 1h-40 stores a basic program for an operation of the main base station, application programs, and data of configuration information. In particular, the storage unit 1h-40 may store information about a bearer allocated to the connected UE and the measurement result reported from the connected UE. Further, the storage unit 1h-40 may store information that becomes the basis of determination of whether to provide or suspend a multi-connection to the UE. Further, the storage unit 1h-40 provides stored data in accordance with a request from the controller 1h-50.

The controller 1h-50 controls the overall operation of the primary base station. For example, the controller 1h-50 transmits and receives signals through the baseband processor 1h-20 and the RF processor 1h-10 or through the backhaul communication unit 1h-30. Further, the controller 1h-50 records or reads data in or from the storage unit 1h-40. For this, the controller 1h-50 may include at least one processor. The controller 1h-50 may further include a multi-connection processor 1h-52 for multi-connection.

The embodiments of the disclosure disclosed in the specification and drawings as described above are merely to present specific examples in order to facilitate the explanation of the contents of the disclosure and to help understanding of the disclosure, but are not intended to limit the scope of the disclosure. Accordingly, the scope of the disclosure should be interpreted to include all modifications or modified forms being derived based on the disclosure in addition to the embodiments disclosed herein.

In addition, some or all described in one or more embodiments of the disclosure may be embodied in combination with some or all of one or more other embodiments, and such forms of embodiments are necessarily within the scope of the disclosure.

What is claimed is:

1. A method performed by a user equipment (UE) in a wireless communication system, the method comprising:
camping on a first cell of a base station based on first system information (SI) received from the first cell;
receiving, from the first cell, second SI including slicing-based cell reselection information;
identifying a second cell to be reselected based on the slicing-based cell reselection information and information about a priority of a slice group received through an upper layer; and
performing a cell reselection procedure for the second cell.

2. The method of claim 1, wherein the slicing-based cell reselection information comprises first information about at least one frequency including at least one cell supporting a slice.

3. The method of claim 2, wherein:
the slicing-based cell reselection information further comprises second information related to an indication of at least one slice group, and
wherein the slice group is composed of at least one single-network slice selection assistance information (S-NSSAI).

4. The method of claim 2, wherein the slicing-based cell reselection information further comprises any one of a first list including at least one cell that supports the slice with respect to a frequency and a second list including at least one cell that does not support the slice with respect to the frequency.

5. The method of claim 4, wherein in case that the first list and the second list are not included in the slicing-based cell reselection information, all cells are considered to support the slice with respect to the frequency.

6. A method performed by a base station in a wireless communication system, the method comprising:
identifying first system information (SI) necessary for a user equipment (UE) to camp on a first cell and second SI including slicing-based cell reselection information;
generating the first SI and the second SI; and
transmitting the first SI and the second SI.

7. The method of claim 6, wherein the slicing-based cell reselection information comprises first information about at least one frequency including at least one cell supporting a slice.

8. The method of claim 7, wherein:
the slicing-based cell reselection information further comprises second information related to an indication of at least one slice group, and
wherein the slice group is composed of at least one single-network slice selection assistance information (S-NSSAI).

9. The method of claim 7, wherein the slicing-based cell reselection information further comprises any one of a first list including at least one cell that supports the slice with respect to a frequency and a second list including at least one cell that does not support the slice with respect to the frequency.

10. The method of claim 9, wherein, in case that the first list and the second list are not included in the slicing-based cell reselection information, all cells are considered to support the slice with respect to the frequency.

11. A user equipment (UE) in a wireless communication system, the UE comprising:
a transceiver configured to transmit and receive signals; and
a controller connected to the transceiver,
wherein the controller is configured to:
camp on a first cell of a base station based on first system information (SI) received from the first cell,
receive, from the first cell, second SI including slicing-based cell reselection information,
identify a second cell to be reselected based on the slicing-based cell reselection information and information about a priority of a slice group received through an upper layer, and
perform a cell reselection procedure for the second cell.

12. The UE of claim 11, wherein the slicing-based cell reselection information comprises first information about at least one frequency including at least one cell supporting a slice.

13. The UE of claim 12, wherein:
the slicing-based cell reselection information further comprises second information related to an indication of at least one slice group, and
wherein the slice group is composed of at least one single-network slice selection assistance information (S-NSSAI).

14. The UE of claim 12, wherein the slicing-based cell reselection information further comprises any one of a first list including at least one cell that supports the slice with respect to a frequency and a second list including at least one cell that does not support the slice with respect to the frequency.

15. The UE of claim 14, wherein in case that the first list and the second list are not included in the slicing-based cell reselection information, all cells are considered to support the slice with respect to the frequency.

16. A base station in a wireless communication system, the base station comprising:
a transceiver configured to transmit and receive signals; and
a controller connected to the transceiver,
wherein the controller is configured to:
identify first system information (SI) necessary for a UE to camp on a first cell and second SI including slicing-based cell reselection information,
generate the first SI and the second SI, and
transmit the first SI and the second SI.

17. The base station of claim 16, wherein the slicing-based cell reselection information comprises first information about at least one frequency including at least one cell supporting a slice.

18. The base station of claim 17, wherein:
the slicing-based cell reselection information further comprises second information related to an indication of at least one slice group, and
wherein the slice group is composed of at least one single-network slice selection assistance information (S-NSSAI).

19. The base station of claim 17, wherein the slicing-based cell reselection information further comprises any one of a first list including at least one cell that supports the slice with respect to a frequency and a second list including at least one cell that does not support the slice with respect to the frequency.

20. The base station of claim 19, wherein in case that the first list and the second list are not included in the slicing-based cell reselection information, all cells are considered to support the slice with respect to the frequency.
